(19) United States
(12) Patent Application Publication
(10) Pub. No.: US 2008/0033124 A1
(43) Pub. Date: Feb. 7, 2008

(54) Polymerization Process

(76) Inventors: Peijun Jiang, League City, TX (US); Charles Stanley Speed, Dayton, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/628,875

(22) PCT Filed: Jun. 20, 2005
(86) PCT No.: PCT/US05/21716

§ 371 Date: Dec. 8, 2006

Related U.S. Application Data
(60) Provisional application No. 60/581,423, filed on Jun. 21, 2004.

(51) Int. Cl. C08F 2/00; C08F 10/00; C08F 4/72

(52) U.S. Cl. 526/65; 526/126; 526/134; 526/160; 526/170

(57) ABSTRACT

This invention relates to processes for preparing polyolefins in the presence of a perfluorocarbon or hydrofluorocarbon with an activated, nonmetallocene, metal-centered, heteroaryl ligand catalyst.

### FIELD OF THE INVENTION

This invention relates to processes for preparing copolymers of propylene and at least one of ethylene and an unsaturated comonomer in the presence of a perfluorocarbon or hydrofluorocarbon.

### BACKGROUND OF THE INVENTION

Polypropylene in its many and varied forms is a long established staple of the polymer industry. Depending upon its form, it exhibits a number of desirable properties including toughness (as measured by any of a number of impact tests, e.g., notched Izod, dart drop, etc.), stiffness (as measured by any of a number of modulus tests e.g., Young's), clarity, chemical resistance and heat resistance. Often a particular combination of properties is desired that requires a balancing of various properties against one another (e.g., stiffness against toughness).

Crystalline polypropylene, typically a homopolymer, is used extensively in various moldings because it exhibits desirable mechanical (e.g., rigidity) and chemical resistance properties. For applications that require impact resistance (e.g., automobile parts, appliance facia, packaging, etc.), a copolymer of propylene and ethylene and/or one or more alpha-olefins is used, or a blend of crystalline polypropylene with one or more polymers that exhibit good impact resistance, e.g., ethylene-propylene (EP) and/or ethylene-propylene-diene (EPDM) rubber. For applications that require toughness and/or heat resistance (e.g., films), preferably the polypropylene has a relatively low melt flow ratio (MFR) or expressed alternatively, a relatively high weight average molecular weight (Mw). For certain applications, such as fibers, preferably the polypropylene has a relatively narrow polydispersity or Mw/Mn (“molecular weight distribution” or “MWD”), e.g., less than 3.5.

Crystalline polypropylene has an isotactic structure, and it is readily produced using a Ziegler-Natta (Z-N) or a metallocene catalyst. While metallocene catalysts are effective for producing propylene homo- and copolymers with a high crystallinity and a relatively narrow MWD, to produce high Mw, e.g., over 300,000, propylene homo- or copolymers economically with a metallocene catalyst is relatively difficult, especially in a solution process. Moreover, the industry maintains a continuing interest in new polypropylene polymers, particularly those for use in high impact and fiber applications.

Propylene copolymers are often produced in slurry processes or solution processes. In a typical solution process, the polymer formed is dissolved in the solvent. The higher the concentration of the polymer in the solvent, the higher the viscosity of the polymerization reaction mixture (also called polymerization media or medium) containing polymer, monomers and solvent. High viscosity in the polymerization reactor in a solution process is often a limiting step for process efficiency and polymer production. High viscosity can lead to difficulties in efficient mixing in the reactor, difficulties in maintaining a homogeneous system, difficulties in avoiding product property drift (heterogeneity), and process control problems. This is especially true for polymerization processes where the polymers produced are to have a molecular weight higher than the entanglement molecular weight. Higher operating temperature may help address these problems by reducing the viscosity of the polymerization medium, however the molecular weight of the polymer product tends to decrease with reaction temperature. Thus production of higher molecular weight polymers in solution processes is limited by the viscosity of the polymerization medium. This problem exists even with the advent of new catalyst systems. Metallocene catalysts (e.g. group 4-7 transition metal compounds having at least one cyclopentadienyl group attached to the metal) allow polymerizations to be performed at a high temperatures, such that a higher polymer concentration of higher molecular weight copolymers (e.g., 16-18 wt % for ethylene-propylene-diene monomer copolymers) can be achieved in the reactor effluent without significant operation difficulties as compared to a conventional solution process (e.g., 7-13 wt % at 30-50° C. for ethylene-propylene-diene monomer copolymers). Similarly, high reaction temperatures tend to improve the polymerization rate and solvent recovery in a solution process, however, the polymer concentration still tends to be much lower than that in an equivalent slurry process. Further, it is also difficult to produce high molecular weight polymers (>100 Mooney) in a solution process due to the nature of high viscosity of a polymer having a Mooney viscosity of 100 or more. Thus there is a need in the art for a means to reduce the viscosity and/or increases the polymer concentration in a solution polymerization process, among other things.

Likewise, the viscosity of a polymer solution is also an important factor in determining process parameters, such as throughput, volume, temperature and the like. In some systems, it is possible to have a higher amount of polymer solute present, however the viscosity of that solution makes it difficult to handle, (i.e. the more viscous the solution, the more difficult it is to pump and the more likely it is to foul). Thus the process may also be limited by solution viscosity and there is a need in the art for means to reduce solution viscosity while maintaining or even increasing solute concentration.

In contrast in slurry phase processes, the viscosity of the polymer slurry does not increases as rapidly as the polymer concentration increases and therefore polymer concentration (or loading) can be increased up to 60% (or more) as compared with less than 20% in solution process. Slurry processes also facilitate the production of high molecular weight polymers due to the lower viscosity as compared to that in solution reactors. Moreover, there is less solvent to remove and the quantity of recycled solvent is reduced considerably in a slurry process. However, it is difficult to produce low crystallinity polymers in a slurry process due to polymer swell and partial dissolving of polymer produced in the hydrocarbon solvent/diluent.

Many polymers are insoluble in the reaction mixture in which they are formed. Upon significant polymerization, they precipitate to form a separate phase. The instant invention provides a process that with proper selection of a fluorinated hydrocarbon(s) or a mixture of fluorinated hydrocarbons and hydrocarbon solvents, the slurry process can produce less swelled polymers and reduce polymer solubility in the solvent. Presence of fluorocarbon(s) in the reaction medium also allows the slurry process to make lower crystallinity polymers. In a solution process, use of fluorocarbon reduces the viscosity and/or increases the polymer concentration in the reaction medium, presumably due to reduced molecular coil dimension.

EP 1 323 746 shows loading of biscyclopentadienyl catalyst onto a silica support in perfluorooctane and thereafter the prepolymerization of ethylene at room temperature.

U.S. Pat. No. 3,056,771 discloses polymerization of ethylene using TiCl₄/(Et)₃Al in a mixture of heptane and perfluoromethylcyclohexane, presumably at room temperature.

### SUMMARY OF THE INVENTION

In a first embodiment, this invention relates to a copolymer of propylene, ethylene and, optionally, one or more unsaturated comonomers, e.g., C4-C20 alpha-olefins, C4-C20 dienes, vinyl aromatic compounds (e.g., styrene), etc. These copolymers are characterized as comprising at least about 60 weight percent (wt %) of units derived from propylene, about 0.1-35 wt % of units derived from ethylene, and 0 to about 35 wt % of units derived from one or more unsaturated comonomers, provided that the combined weight percent of units derived from ethylene and the unsaturated comonomer does not exceed about 40. These copolymers are also characterized as having at least 10 ppm of residual fluorine present, preferably between 10 and 10,000 ppm of fluorine present, preferably between 10 and 1000 ppm.

In a second embodiment, the invention is a copolymer of propylene and one or more unsaturated comonomers. These copolymers are characterized in having at least about 60 wt % of the units derived from propylene, and between about 0.1 and 40 wt % the units derived from the unsaturated comonomer. These copolymers are also characterized as having at least 10 ppm of residual fluorine present, preferably between 10 and 10,000 ppm of fluorine present, preferably between 10 and 1000 ppm.

In a third embodiment, the invention is a blend of two or more copolymers in which at least one copolymer is at least one of the propylene/ethylene and propylene/unsaturated comomoner copolymers described in the first and second embodiments (individually and collectively “P/E* copolymer”). The amount of each component in the blend can vary to convenience. The blend may contain any weight percent, based on the total weight of the blend, of either component, and the blend may be either homo- or heterophasic. If the later, the copolymer of the first or second embodiment of this invention can be either the continuous or discontinuous (i.e., dispersed) phase.

In a fourth embodiment, the invention is a blend of (a) at least one propylene homopolymer, and (b) at least one other polymer, e.g. an EP or EPDM rubber.

The at least one other polymer of (b) of this fourth embodiment is any polymer other than a P/E* copolymer. Typically and preferably, this other polymer(s) is (are) a polyolefin such as one or more of a polyethylene, ethylene/alpha-olefin, butylene/alpha-olefin, ethylene/styrene and the like. The blend may contain any weight percent, based on the total weight of the blend, of either component, and the blend may be either homo- or heterophasic. If the later, the propylene homopolymer can be either the continuous or dispersed phase.

In a fifth embodiment, the invention is a process for making a P/E* copolymer, the process comprising contacting propylene and at least one of ethylene and/or one or more unsaturated comonomers under polymerization conditions in the presence of a perfluorocarbon and or a hydrofluorocarbon with an activated, nonmetallocene, metal-centered, heteroaryl ligand catalyst. The process can be conducted in the solution, slurry or gas phase using conventional polymerization conditions and equipment.

In a sixth embodiment, the invention is a solution phase process for making a high Mw, narrow MWD P/E* copolymer, the process comprising contacting propylene and at least one of ethylene and one or more unsaturated comonomers under polymerization conditions in the presence of a perfluorocarbon and or a hydrofluorocarbon with an activated, nonmetallocene, metal-centered, heteroaryl ligand catalyst.

In a seventh embodiment, the invention is a series reactor process for making a polymer blend, the blend comprising (A) a P/E* copolymer of this invention, and (B) a propylene homopolymer and/or a second copolymer. The series reactor process of this embodiment has two or more reactors. One variation of this process comprises:
1. Contacting in a first reactor (a) propylene, (b) ethylene, and (c) a catalyst under polymerization conditions, optionally, in the presence of a perfluorocarbon and or a hydrofluorocarbon to make a P/E copolymer, the propylene, ethylene, catalyst, and P/E copolymer forming a reaction mass within the first reactor;
2. Transferring the reaction mass of the first reactor to a second reactor;
3. Feeding additional propylene and/or ethylene to the second reactor;
4. Contacting within the second reactor under polymerization conditions, optionally, in the presence of a perfluorocarbon and or a hydrofluorocarbon, the additional propylene and/or propylene fed to the second reactor with the reaction mass from the first reactor to make the polypropylene homopolymer or the second copolymer; and
5. Recovering the blend from the second reactor, provided that at least one of the polymerizations in the first or the second reactor occurs in the presence of a perfluorocarbon and or a hydrofluorocarbon. In one embodiment, the first polymerization takes place in the presence of a perfluorocarbon and or a hydrofluorocarbon. In another embodiment, the second polymerization takes place in the presence of a perfluorocarbon and or a hydrofluorocarbon. In a third embodiment, both polymerizations takes place in the presence of a perfluorocarbon and or a hydrofluorocarbon.

In one variation, one or both of the P/E copolymer and the second copolymer is a P/E* copolymer.

In another variation on this embodiment, the process comprises:

A. Contacting in a first reactor (i) propylene, (ii) ethylene, and (iii) an activated, nonmetallocene, metal-centered, heteroaryl ligand catalyst under polymerization conditions, optionally in the presence of a perfluorocarbon or a hydrofluorocarbon, such that at least about 50 wt % of the propylene and substantially all of the ethylene are converted to a P/E* copolymer, the propylene, ethylene, catalyst, and P/E* copolymer forming a reaction mass within the first reactor;

B. Transferring the reaction mass of the first reactor to a second reactor;

C. Optionally, feeding additional propylene to the second reactor;

D. Contacting within the second reactor under polymerization conditions, optionally in the presence of a perfluorocarbon or a hydrofluorocarbon, the propylene fed to the second reactor with the reaction mass from the first reactor to make the propylene homopolymer or the second copolymer; and

E. Recovering the blend from the second reactor; provided that at least one of the polymerizations in the first or the second reactor occurs in the presence of a perfluorocarbon and or a hydrofluorocarbon. In one embodiment, the first polymerization takes place in the presence of a perfluorocarbon and or a hydrofluorocarbon. In another embodiment, the second polymerization takes place in the presence of a perfluorocarbon and or a hydrofluorocarbon. In a third embodiment, both polymerizations takes place in the presence of a perfluorocarbon and or a hydrofluorocarbon.

If (i) the only comonomers fed to the first reactor are propylene and ethylene, (ii) substantially all of the ethylene is consumed (i.e., converted to polymer), and (iii) only propylene is fed to the second reactor (as unreacted propylene from the first reactor and/or as added propylene), then only propylene polymer containing minor, if any, amounts of ethylene is made in the second reactor.

One interesting feature of certain of the nonmetallocene metal-centered, heteroaryl ligand catalysts used in the practice of this invention is the ability to convert a very high percentage of ethylene monomer to P/E* copolymer in a reactor during a propylene/ethylene copolymerization reaction. For example, with a propylene conversion of about 50% or more, the ethylene conversion may be about 90% or higher. Preferably, the ethylene conversion may be higher than about 95%, more preferably greater than about 97%, even more preferably greater than about 98%, or most preferably greater than about 99%.

One consequence of this high ethylene conversion is that, in a multiple-reactor process, a tough, high Mw propylene/ethylene copolymer can be prepared in one reactor which consumes the majority of the ethylene in the process. Subsequent reactors will experience a greatly reduced ethylene concentration, which can allow for the production of high melting point propylene homopolymer or interpolymers. Preferably, the peak crystallization temperature in a DSC cooling curve of the propylene copolymer comprising propylene and ethylene made in one reactor using a catalyst comprising a nonmetallocene, metal-centered, heteroaryl ligand catalyst is at least 10° C. lower than the peak crystallization temperature in a DSC cooling curve of the propylene interpolymer comprising propylene and ethylene made in a subsequent reactor. Preferably, the peak crystallization temperature is at least 15, more preferably 20, most preferably 40° C. lower. Preferably, at least 2 reactors are used in series, and the process is a solution, slurry, or gas-phase process, or a combination of two or more of these processes. For economic reasons, a continuous process is preferred, but batch or semi-batch processes can also be employed.

By continuous is meant a system that operates (or is intended to operate) without interruption or cessation. For example a continuous process to produce a polymer would be one where the reactants are continually introduced into one or more reactors and polymer product is continually withdrawn. In a preferred embodiment any of the polymerization process described herein are a continuous process.

In another variation on this embodiment of the invention, the order of the reactors is reversed. In this arrangement, propylene homopolymer, or a propylene copolymer containing only minor amounts of ethylene, as described below, can be made in the first reactor (to which the only monomer fed is propylene) and a copolymer of the first embodiment of this invention is made in the second reactor (to which is fed both propylene and ethylene, and optionally, one or more unsaturated comonomers). This arrangement can be particularly useful for gas phase reactions, but also may be used in a solution or slurry process. Irrespective of the order of the reactors, for this embodiment of the invention it should be appreciated that, when the process is a continuous process involving recovery of the polymer product, recovery of the solvent (if any) and unreacted monomers, and recycle of the solvent (if any) and unreacted monomers to the reactors, small amounts of unconverted ethylene may be present in the recycle stream. For the purposes of this invention, when it is stated that only propylene (or only any other particular monomer(s)) is added to any reactor in such a process, that small amounts of ethylene or other monomers may be present in the recycle stream.

The reactors are operated such that the polymer made in one reactor is different from the polymer made in at least one other reactor. These operational differences include using (i) different weight or mole ratios of propylene, ethylene and/or unsaturated comonomer, (ii) catalysts (each reactor containing a different activated, nonmetallocene, metal-centered, heteroaryl ligand catalyst, or one or more reactors containing an activated nonmetallocene, metal-centered, heteroaryl ligand catalyst and one or more other reactors containing another type of catalyst, e.g., a metallocene catalyst, a Ziegler-Natta (Z-N) catalyst, a constrained geometry catalyst, etc., and/or (iii) operating parameters. One or more reactors can contain more than one catalyst, e.g., one reactor can contain both a metallocene and a Z-N catalyst.

In an eighth embodiment, the invention is a parallel reactor process for making a polymer blend, the blend comprising (a) a P/E* copolymer, and (b) a propylene homopolymer and/or a second copolymer. One variation of this process comprises:

A. Contacting in a first reactor under polymerization conditions propylene and, optionally, one or more of ethylene and an unsaturated comonomer to make the first polymer;

B. Contacting in a second reactor under polymerization conditions propylene and, optionally, one or more of ethylene and an unsaturated comonomer to make the second polymer;

C. Recovering the first polymer from the first reactor and the second polymer from the second reactor; and

D. Blending the first and second polymers to form the polymer blend; such that at least one of the first and second polymers comprise a P/E* copolymer made with a nonmetallocene, metal-centered, heteroaryl ligand catalyst; and provided that at least one of the polymerizations in the first or the second reactor occurs in the presence of a perfluorocarbon and or a hydrofluorocarbon. In a preferred method of operating such embodiments, the first polymerization takes place in the presence of a perfluorocarbon and or a hydrofluorocarbon. In another embodiment, the second polymerization takes place in the presence of a perfluorocarbon and or a hydrofluorocarbon. In a third embodiment, both polymerizations takes place in the presence of a perfluorocarbon and or a hydrofluorocarbon.

The first and second reactors are operated such that the first and second polymers are different from one another. These operational differences include using different weight or mole ratios of propylene, ethylene and/or unsaturated comonomer, catalysts (each reactor containing a different nonmetallocene, metal-centered, heteroaryl ligand catalyst, or one or more reactors containing a nonmetallocene, metal-centered, heteroaryl ligand catalyst and one or more other reactors containing a catalyst other than a nonmetallocene, metal-centered, heteroaryl ligand catalyst), and/or operating parameters.

The nonmetallocene, metal-centered, heteroaryl ligand catalysts used in the practice of this invention are used in combination with one or more activators, e.g., an alumoxane. In certain embodiments, the metal is one or more of hafnium and zirconium.

More specifically, in certain embodiments of the catalyst, the use of a hafnium metal is preferred as compared to a zirconium metal for heteroaryl ligand catalysts. A broad range of ancillary ligand substituents may accommodate the enhanced catalytic performance. The catalysts in certain embodiments are compositions comprising the ligand and metal precursor, and, optionally, may additionally include an activator, combination of activators or activator package.

The catalysts used in the practice of this invention additionally include catalysts comprising ancillary ligand-hafnium complexes, ancillary ligand-zirconium complexes and optionally activators, which catalyze polymerization and copolymerization reactions, particularly with monomers that are olefins, diolefins or other unsaturated compounds. Zirconium complexes, hafnium complexes, compositions or compounds using the disclosed ligands are within the scope of the catalysts useful in the practice of this invention. The metal-ligand complexes may be in a neutral or charged state. The ligand to metal ratio may also vary, the exact ratio being dependent on the nature of the ligand and metal-ligand complex. The metal-ligand complex or complexes may take different forms, for example, they may be monomeric, dimeric or of an even higher order.

For example, suitable ligands useful in the practice of this invention may be broadly characterized by the following general formula (1): 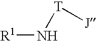
wherein R¹ is a ring having from 4-8 atoms in the ring generally selected from the group consisting of substituted cycloalkyl, substituted heterocycloalkyl, substituted aryl and substituted heteroaryl, such that R¹ may be characterized by the general formula (2): 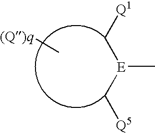
where Q¹ and Q⁵ are substituents on the ring other than to atom E, with E being selected from the group consisting of carbon and nitrogen and with at least one of Q¹ or Q⁵ being bulky (defined as having at least 2 atoms). Q″_{q} represents additional possible substituents on the ring, with q being 1, 2, 3, 4 or 5 and Q″ being selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof. T is a bridging group selected group consisting of —CR²R³— and —SiR²R³— with R² and R³ being independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof. J″ is generally selected from the group consisting of heteroaryl and substituted heteroaryl, with particular embodiments for particular reactions being described herein.

Also for example, in some embodiments, the ligands of the catalyst used in the practice of this invention may be combined with a metal precursor compound that may be characterized by the general formula Hf(L)ₙ where L is independently selected from the group consisting of halide (F, Cl, Br, I), alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 1, 2, 3, 4, 5, or 6.

In certain aspects, certain ligands complex to the metal can be used in the practice of this invention. In one aspect, the 3,2 metal-ligand complexes that can be used in the practice of this invention may be generally characterized by the following formula (3): 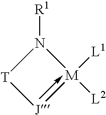
where M is zirconium or hafnium;
R¹ and T are as defined above;

J″′ being selected from the group of substituted heteroaryls with 2 atoms bonded to the metal M, at least one of those atoms being a heteroatom, and with one atom of J″′ is bonded to M via a dative bond, the other through a covalent bond; and

L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations of these radicals.

In a ninth embodiment, the invention is the use of the polypropylene homo- and copolymers to make various fabricated articles. These polymers are particularly useful in the manufacture of such shaped articles as films, sheets, fibers, foams and molded articles.

Ideally, the fluorocarbon is inert to the polymerization reaction. By “inert to the polymerization reaction” is meant that the fluorocarbon does not react chemically with the, monomers, catalyst system or the catalyst system components. (This is not to say that the physical environment provided by an FC's does not influence the polymerization reactions, in fact, it may do so to some extent, such as affecting activity rates. However, it is meant to say that the FC's are not present as part of the catalyst system.)

### DETAILED DESCRIPTION

Molecular Weight Mw, Mn, Mz are determined by the procedure listed in the examples section.

The weight average molecular weight (Mw) of the polymers of this invention can vary widely, but typically it is between about 30,000 and 1,000,000 (with the understanding that the only limit on the minimum or the maximum Mw is that set by practical considerations). Preferably the minimum Mw is about 50,000, more preferably about 75,000 and even more preferably about 100,000. “High molecular weight”, “high weight average molecular weight”, “high Mw” and similar terms mean a weight average molecular weight of at least about 250,000, preferably of at least about 300,000 and more preferably 350,000, and more preferably at least about 400,000.

Polydispersity

The polydispersity (also called molecular weight distribution, MWD or Mw/Mn) of the polymers of this invention is typically between about 2 and about 6. “Narrow polydispersity”, “narrow molecular weight distribution”, “narrow MWD” and similar terms mean a ratio (Mw/Mn) of weight average molecular weight (Mw) to number average molecular weight (Mn) of less than about 3.5, preferably less than about 3.0, more preferably less than about 2.8, more preferably less than about 2.5, and most preferably less than about 2.3. Polymers for use in fiber and extrusion coating applications typically have a narrow polydispersity.

Blends comprising the inventive polymers may have a higher polydispersity, depending on the molecular weight of the other components of the blend. In particular, blends produced utilizing any of the multiple reactor processes disclosed in the present invention may have a broad range of polydispersities, from as low as about 2 to as high as 100 or more. Preferably, the Mw/Mn of such blends is between about 2 and about 50, more preferably between about 2 and about 20, most preferably between about 2 and about 10.

Polymer Definitions and Descriptions

“Polymer” means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like. The terms “monomer” or “comonomer” are used interchangeably, and they refer to any compound with a polymerizable moiety which is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

“Metallocene-catalyzed polymer” or similar term means any polymer that is made in the presence of a metallocene catalyst. “Constrained geometry catalyst catalyzed polymer”, “CGC-catalyzed polymer” or similar term means any polymer that is made in the presence of a constrained geometry catalyst. “Ziegler-Natta-catalyzed polymer”, Z-N-catalyzed polymer” or similar term means any polymer that is made in the presence of a Ziegler-Natta catalyst. “Metallocene” means a metal-containing compound having at least one substituted or unsubstituted cyclopentadienyl group bound to the metal. “Constrained geometry catalyst” or “CGC” as here used has the same meaning as this term is defined and described in U.S. Pat. Nos. 5,272,236 and 5,278,272.

“Random copolymer” means a copolymer in which the monomer is randomly distributed across the polymer chain. “Impact copolymer” means two or more polymers in which one polymer is dispersed in the other polymer, typically one polymer comprising a matrix phase and the other polymer comprising an elastomer phase. The matrix polymer is typically a crystalline polymer, e.g., polypropylene homopolymer or copolymer, and the polymer comprising the elastomer phase is typically a rubber or elastomer, e.g., an EP or an EPDM rubber. The polymer that forms the elastomer phase typically comprises between about 5 and about 50, preferably between about 10 and 45 and more preferably between about 10 and 40, weight percent of the impact polymer.

“Propylene homopolymer” and similar terms mean a polymer consisting solely or essentially all of units derived from propylene. “Polypropylene copolymer” and similar terms mean a polymer comprising units derived from propylene and ethylene and/or one or more unsaturated comonomers. The term “copolymer” includes terpolymers, tetrapolymers, etc.

The unsaturated comonomers used in the practice of this invention include, C4-C20 alpha-olefins, especially C4-C12 alpha-olefins such as 1-butene, 1-pentene, 1-hexene, 4-methyl-1-pentene, 1-heptene, 1-octene, 1-decene, 1-dodecene and the like; C4-C20 diolefins, preferably 1,3-butadiene, 1,3-pentadiene, norbornadiene, 5-ethylidene-2-norbornene (ENB) and dicyclopentadiene; C8-C40 vinyl aromatic compounds including sytrene, o-, m-, and p-methylstyrene, divinylbenzene, vinylbiphenyl, vinylnapthalene; and halogen-substituted C8-C40 vinyl aromatic compounds such as chlorostyrene and fluorostyrene. In some embodiments of this invention, ethylene is not included in the definition of unsaturated comonomers. Preferred dienes include both cis and trans 1,4-hexadiene.

Polymers produced according to this invention are olefin polymers or “polyolefins”. By olefin polymers is meant that at least 75 mole % of the polymer is made of hydrocarbon monomers, preferably at least 80 mole %, preferably at least 85 mole %, preferably at least 90 mole %, preferably at least 95 mole %, preferably at least 99 mole %. In a particularly preferred embodiment, the polymers are 100 mole % hydrocarbon monomer. Hydrocarbon monomers are monomers made up of only carbon and hydrogen. In another embodiment of the invention up to 25 mol % of the polyolefin is derived from heteroatom containing monomers. Heteroatom containing monomers are hydrocarbon monomers where one or more hydrogen atoms have been replaced by a heteroatom. In a preferred embodiment, the heteroatom is selected from the group consisting of chlorine, bromine, oxygen, nitrogen, silicon and sulfur, preferably the heteroatom is selected from the group consisting of oxygen, nitrogen, silicon and sulfur, preferably the heteroatom is selected from the group consisting of oxygen and nitrogen, preferably oxygen. In a preferred embodiment, the heteroatom is not fluorine. In another embodiment of the invention, the monomers to be polymerized are not fluoromonomers. Fluoromonomers are defined to be hydrocarbon monomers where at least one hydrogen atom has been replaced by a fluorine atom. In another embodiment of the invention, the monomers to be polymerized are not halomonomers. (By halomonomer is meant a hydrocarbon monomer where at least one hydrogen atom is replaced by a halogen.) In another embodiment of the invention, the monomers to be polymerized are not vinyl aromatic hydrocarbons. In another embodiment of the invention, the monomers to be polymerized are preferably aliphatic or alicyclic hydrocarbons. (as defined under “Hydrocarbon” in Hawley's Condensed Chemical Dictionary, 13th edition, R. J. Lewis ed., John Wiley and Sons, New York, 1997. In another embodiment of the invention, the monomers to be polymerized are preferably linear or branched alpha-olefins, preferably C2 to C40 linear or branched alpha-olefins, preferably C2 to C20 linear or branched alpha-olefins, preferably ethylene, propylene, butene, pentene, hexene, heptene, octene, nonene, decene, undecene, dodecene, or mixtures thereof, more preferably ethylene, propylene, butene hexene and octene.

The propylene copolymers of this invention typically comprise units derived from propylene in an amount of at least about 60, preferably at least about 80 and more preferably at least about 85, wt % of the copolymer. The typical amount of units derived from ethylene in propylene/ethylene copolymers is at least about 0.1, preferably at least about 1 and more preferably at least about 5 wt %, and the maximum amount of units derived from ethylene present in these copolymers is typically not in excess of about 35, preferably not in excess of about 30 and more preferably not in excess of about 20, wt % of the copolymer. The amount of units derived from the unsaturated comonomer(s), if present, is typically at least about 0.01, preferably at least about 1 and more preferably at least about 5, wt %, and the typical maximum amount of units derived from the unsaturated comonomer(s) typically does not exceed about 35, preferably it does not exceed about 30 and more preferably it does not exceed about 20, wt % of the copolymer. The combined total of units derived from ethylene and any unsaturated comonomer typically does not exceed about 40, preferably it does not exceed about 30 and more preferably it does not exceed about 20, wt % of the copolymer.

The copolymers of this invention comprising propylene and one or more unsaturated comonomers (other than ethylene) also typically comprise units derived from propylene in an amount of at least about 60, preferably at least about 70 and more preferably at least about 80, wt % of the copolymer. The one or more unsaturated comonomers of the copolymer comprise at least about 0.1, preferably at least about 1 and more preferably at least about 3, weight percent, and the typical maximum amount of unsaturated comonomer does not exceed about 40, and preferably it does not exceed about 30, wt % of the copolymer.

Melt Flow Rate (MFR)

The propylene copolymers of this invention typically have an MFR of at least about 0.01 dg/min, preferably at least about 0.05, more preferably at least about 0.1 and most preferably at least about 0.2. The maximum MFR typically does not exceed about 1,000 dg/min, preferably it does not exceed about 500, more preferably it does not exceed about 100, further more preferably it does not exceed about 80 and most preferably it does not exceed about 50. MFR for polypropylene and copolymers of propylene and ethylene and/or one or more C4-C20 alpha olefins is measured according to ASTM D-1238, condition L (2.16 kg, 230° C.).

Propylene Copolymers

The propylene copolymers of this invention of particular interest include propylene/ethylene, propylene/1-butene, propylene/1-hexene, propylene/4-methyl-1-pentene, propylene/1-octene, propylene/ethylene/1-butene, propylene/ethylene/ENB, propylene/ethylene/1-hexene, propylene/ethylene/1-octene, propylene/styrene, and propylene/ethylene/styrene.

Catalyst Definitions and Descriptions

The propylene copolymers of this invention are prepared by a process comprising contacting, under solution, slurry or gas phase polymerization conditions and in the presence of a hydrofluorocarbon and or a perfluorocarbon, propylene and at least one of ethylene and one or more unsaturated monomers with a nonmetallocene, metal-centered, heteroaryl ligand catalyst. Propylene homopolymers are similarly prepared by a process comprising contacting, under solution, slurry or gas phase polymerization conditions and in the presence of a hydrofluorocarbon and or a perfluorocarbon, propylene with a nonmetallocene, metal-centered, heteroaryl ligand catalyst. “Nonmetallocene” means that the metal of the catalyst is not attached to a substituted or unsubstituted cyclopentadienyl ring. Representative nonmetallocene, metal-centered, heteroarly ligand catalysts are described in U.S. Provisional Patent Application No. 60/246,781 filed Nov. 7, 2000 and No. 60/301,666 filed Jun. 28, 2001.

As here used, “nonmetallocene, metal-centered, heteroaryl ligand catalyst” means the catalyst derived from the ligand described in formula (1). As used in this phrase, “heteroaryl” includes substituted heteroaryl.

As used herein, the phrases “characterized by the formula” and “represented by the formula” are not intended to be limiting and is used in the same way that “comprising” is commonly used. The term “independently selected” is used herein to indicate that the R groups, e.g., R¹, R², R³, R⁴, and R⁵ can be identical or different (e.g. R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. The terms “compound” and “complex” are generally used interchangeably in this specification, but those of skill in the art may recognize certain compounds as complexes and vice versa. For the purposes of illustration, representative certain groups are defined herein. These definitions are intended to supplement and illustrate, not preclude, the definitions known to those of skill in the art.

“Hydrocarbyl” refers to univalent hydrocarbyl radicals containing 1 to about 30 carbon atoms, preferably 1 to about 24 carbon atoms, most preferably 1 to about 12 carbon atoms, including branched or unbranched, saturated or unsaturated species, such as alkyl groups, alkenyl groups, aryl groups, and the like. “Substituted hydrocarbyl” refers to hydrocarbyl substituted with one or more substituent groups, and the terms “heteroatom-containing hydrocarbyl” and “heterohydrocarbyl” refer to hydrocarbyl in which at least one carbon atom is replaced with a heteroatom.

The term “alkyl” is used herein to refer to a branched or unbranched, saturated or unsaturated acyclic hydrocarbon radical. Suitable alkyl radicals include, for example, methyl, ethyl, n-propyl, i-propyl, 2-propenyl (or allyl), vinyl, n-butyl, t-butyl, i-butyl (or 2-methylpropyl), etc. In particular embodiments, alkyls have between 1 and 200 carbon atoms, between 1 and 50 carbon atoms or between 1 and 20 carbon atoms.

“Substituted alkyl” refers to an alkyl as just described in which one or more hydrogen atom bound to any carbon of the alkyl is replaced by another group such as a halogen, aryl, substituted aryl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and combinations thereof. Suitable substituted alkyls include, for example, benzyl, trifluoromethyl and the like.

The term “heteroalkyl” refers to an alkyl as described above in which one or more hydrogen atoms to any carbon of the alkyl is replaced by a heteroatom selected from the group consisting of N, O, P, B, S, Si, Sb, Al, Sn, As, Se and Ge. This same list of heteroatoms is useful throughout this specification. The bond between the carbon atom and the heteroatom may be saturated or unsaturated. Thus, an alkyl substituted with a heterocycloalkyl, substituted heterocycloalkyl, heteroaryl, substituted heteroaryl, alkoxy, aryloxy, boryl, phosphino, amino, silyl, thio, or seleno is within the scope of the term heteroalkyl. Suitable heteroalkyls include cyano, benzoyl, 2-pyridyl, 2-furyl and the like.

The term “cycloalkyl” is used herein to refer to a saturated or unsaturated cyclic non-aromatic hydrocarbon radical having a single ring or multiple condensed rings. Suitable cycloalkyl radicals include, for example, cyclopentyl, cyclohexyl, cyclooctenyl, bicyclooctyl, etc. In particular embodiments, cycloalkyls have between 3 and 200 carbon atoms, between 3 and 50 carbon atoms or between 3 and 20 carbon atoms.

“Substituted cycloalkyl” refers to cycloalkyl as just described including in which one or more hydrogen atom to any carbon of the cycloalkyl is replaced by another group such as a halogen, alkyl, substituted alkyl, aryl, substituted aryl, cycloalkyl, substituted cycloalkyl, heterocycloalkyl, substituted heterocycloalkyl, heteroaryl, substituted heteroaryl, alkoxy, aryloxy, boryl, phosphino, amino, silyl, thio, seleno and combinations thereof. Suitable substituted cycloalkyl radicals include, for example, 4-dimethylaminocyclohexyl, 4,5-dibromocyclohept-4-enyl, and the like.

The term “heterocycloalkyl” is used herein to refer to a cycloalkyl radical as described, but in which one or more or all carbon atoms of the saturated or unsaturated cyclic radical are replaced by a heteroatom such as nitrogen, phosphorous, oxygen, sulfur, silicon, germanium, selenium, or boron. Suitable heterocycloalkyls include, for example, piperazinyl, morpholinyl, tetrahydropyranyl, tetrahydrofuranyl, piperidinyl, pyrrolidinyl, oxazolinyl and the like.

“Substituted heterocycloalkyl” refers to heterocycloalkyl as just described including in which one or more hydrogen atom to any atom of the heterocycloalkyl is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heterocycloalkyl radicals include, for example, N-methylpiperazinyl, 3-dimethylaminomorpholinyl and the like.

The term “aryl” is used herein to refer to an aromatic substituent which may be a single aromatic ring or multiple aromatic rings which are fused together, linked covalently, or linked to a common group such as a methylene or ethylene moiety. The aromatic ring(s) may include phenyl, naphthyl, anthracenyl, and biphenyl, among others. In particular embodiments, aryls have between 1 and 200 carbon atoms, between 1 and 50 carbon atoms or between 1 and 20 carbon atoms.

“Substituted aryl” refers to aryl as just described in which one or more hydrogen atom bound to any carbon is replaced by one or more functional groups such as alkyl, substituted alkyl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and both saturated and unsaturated cyclic hydrocarbons which are fused to the aromatic ring(s), linked covalently or linked to a common group such as a methylene or ethylene moiety. The common linking group may also be a carbonyl as in benzophenone or oxygen as in diphenylether or nitrogen in diphenylamine.

The term “heteroaryl” as used herein refers to aromatic or unsaturated rings in which one or more carbon atoms of the aromatic ring(s) are replaced by a heteroatom(s) such as nitrogen, oxygen, boron, selenium, phosphorus, silicon or sulfur. Heteroaryl refers to structures that may be a single aromatic ring, multiple aromatic ring(s), or one or more aromatic rings coupled to one or more non-aromatic ring(s). In structures having multiple rings, the rings can be fused together, linked covalently, or linked to a common group such as a methylene or ethylene moiety. The common linking group may also be a carbonyl as in phenyl pyridyl ketone. As used herein, rings such as thiophene, pyridine, isoxazole, pyrazole, pyrrole, furan, etc. or benzo-fused analogues of these rings are defined by the term “heteroaryl.”

“Substituted heteroaryl” refers to heteroaryl as just described including in which one or more hydrogen atoms bound to any atom of the heteroaryl moiety is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heteroaryl radicals include, for example, 4-N,N-dimethylaminopyridine.

The term “alkoxy” is used herein to refer to the —OZ¹ radical, where Z¹ is selected from the group consisting of alkyl, substituted alkyl, cycloalkyl, substituted cycloalkyl, heterocylcoalkyl, substituted heterocycloalkyl, silyl groups and combinations thereof as described herein. Suitable alkoxy radicals include, for example, methoxy, ethoxy, benzyloxy, t-butoxy, etc. A related term is “aryloxy” where Z¹ is selected from the group consisting of aryl, substituted aryl, heteroaryl, substituted heteroaryl, and combinations thereof. Examples of suitable aryloxy radicals include phenoxy, substituted phenoxy, 2-pyridinoxy, 8-quinalinoxy and the like.

As used herein the term “silyl” refers to the —SiZ¹Z²Z³ radical, where each of Z¹ and Z² and Z³ is independently selected from the group consisting of hydrogen, alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein the term “boryl” refers to the —BZ¹Z² group, where each of Z¹ and Z² is independently selected from the group consisting of hydrogen, alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein, the term “phosphino” refers to the group: —PZ¹Z², where each of Z¹ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof.

As used herein, the term “phosphine” refers to the group: —PZ¹Z²Z³, where each of Z¹ and Z² and Z³ is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof.

The term “amino” is used herein to refer to the group —NZ¹Z², where each of Z¹ and Z² is independently selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “amine” is used herein to refer to the group: —NZ¹Z²Z³, where each of Z¹ and Z² and Z³ is independently selected from the group consisting of hydrogen, alkyl, substituted alkyl, cycloalkyl, substituted cycloalkyl, heterocycloalkyl, substituted heterocycloalkyl, aryl (including pyridines), substituted aryl, heteroaryl, substituted heteroaryl, alkoxy, aryloxy, silyl and combinations thereof.

The term “thio” is used herein to refer to the group —SZ¹, where Z¹ is selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “seleno” is used herein to refer to the group —SeZ¹, where Z¹ is selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “saturated” refers to lack of double and triple bonds between atoms of a radical group such as ethyl, cyclohexyl, pyrrolidinyl, and the like.

The term “unsaturated” refers to the presence one or more double and/or triple bonds between atoms of a radical group such as vinyl, acetylide, oxazolinyl, cyclohexenyl, acetyl and the like.

Ligands

Suitable ligands useful in the catalysts used in the practice of this invention can be characterized broadly as monoanionic ligands having an amine and a heteroaryl or substituted heteroaryl group. The ligands of the catalysts used in the practice of this invention are referred to, for the purposes of this invention, as nonmetallocene ligands, and may be characterized by the following general formula (1): 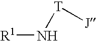
wherein R¹ is very generally selected from the group consisting of alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl and combinations thereof. In many embodiments, R¹ is a ring having from 4-8 atoms in the ring generally selected from the group consisting of substituted cycloalkyl, substituted heterocycloalkyl, substituted aryl and substituted heteroaryl, such that R¹ may be characterized by the general formula (2): 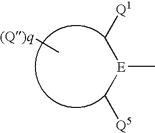
where Q¹ and Q⁵ are substituents on the ring ortho to atom E, with E being selected from the group consisting of carbon and nitrogen and with at least one of Q¹ or Q⁵ being bulky (defined as having at least 2 atoms). Q¹ and Q⁵ are independently selected from the group consisting of alkyl, substituted alkyl, cycloalkyl, substituted cycloalkyl, aryl, substituted aryl and silyl, but provided that Q¹ and Q⁵ are not both methyl. Q″_{q} represents additional possible substituents on the ring, with q being 1, 2, 3, 4 or 5 and Q″ being selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof. T is a bridging group selected group consisting of —CR²R³— and —SiR²R³— with R² and R³ being independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof. J″ is generally selected from the group consisting of heteroaryl and substituted heteroaryl, with particular embodiments for particular reactions being described herein.

In a more specific embodiment, suitable nonmetallocene ligands useful in this invention may be characterized by the following general formula (4): 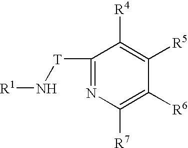
wherein R¹ and T are as defined above and each of R⁴, R⁵, R⁶ and R⁷ is independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof. Optionally, any combination of R⁴, R⁵, R⁶ and R⁷ may be joined together in a ring structure.

In certain more specific embodiments, the ligands in this invention may be characterized by the following general formula (5): 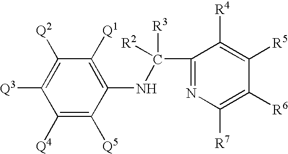
wherein Q¹, Q⁵, R⁴, R⁵, R⁶ and R⁷ are as defined above. Q², Q³, Q⁴, R², and R³ are independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, nitro, and combinations thereof.

In other more specific embodiments, the ligands of this invention and suitable herein may be characterized by the following general formula (6): 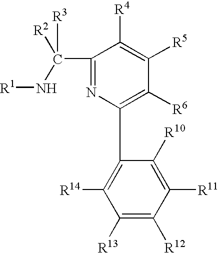
wherein R¹, R², R³, R⁴, R⁵, and R⁶ are as defined above. In this embodiment the R⁷ substituent has been replaced with an aryl or substituted aryl group, with R¹⁰, R¹¹, R¹² and R¹³ being independently selected from the group consisting of hydrogen, halo, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, nitro, and combinations thereof, optionally, two or more R¹⁰, R¹¹, R¹² and R¹³ groups may be joined to form a fused ring system having from 3-50 non-hydrogen atoms. R¹⁴ is selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, halide, nitro, and combinations thereof.

In still more specific embodiments, the ligands in this invention may be characterized by the general formula (7): 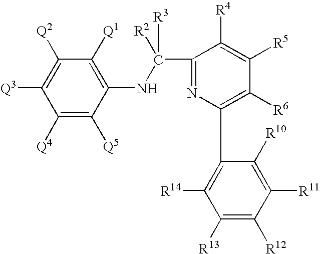
wherein R²-R⁶, R¹⁰-R¹⁴ and Q¹-Q⁵ are all as defined above.

In certain embodiments, R² is preferably hydrogen. Also preferably, each of R⁴ and R⁵ is hydrogen and R⁶ is either hydrogen or is joined to R⁷ to form a fused ring system. Also preferred is where R³ is selected from the group consisting of benzyl, phenyl, 2-biphenyl, t-butyl, 2-dimethylaminophenyl (2-(NMe₂)—C₆H₄—) (where Me is methyl), 2-methoxyphenyl (2-MeO—C₆H₄—), anthracenyl, mesityl, 2-pyridyl, 3,5-dimethylphenyl, o-tolyl, 9phenanthrenyl. Also preferred is where R¹ is selected from the group consisting of mesityl, 4 isopropylphenyl (4-Prⁱ—C₆H₄—), napthyl, 3,5-(CF₃)₂—C₆H₃, 2-Me-napthyl, 2,6-(Prⁱ)₂—C₆H₃—, 2-biphenyl, 2-Me-4-MeO—C₆H₃—; 2-Bu^{t}—C₆H₄—, 2,5-(Bu^{t})₂.—C₆H₃—, 2-Prⁱ-6-Me-C₆H₃—; 2-Bu^{t}-6-Me-C₆H₃—, 2,6-Et₂-C₆H₃—, 2-sec-butyl-6-Et-C₆H₃—. Also preferred is where R⁷ is selected from the group consisting of hydrogen, phenyl, napthyl, methyl, anthracenyl, 9-phenanthrenyl, mesityl, 3,5-(CF₃)₂—C₆H₃—, 2-CF₃—C₆H₄—, 4-CF₃—C₆H₄—, 3,5-F₂—C₆H₃—, 4-F—C₆H₄—, 2,4-F₂—C₆H₃—, 4-(NMe₂)-C₆H₄—, 3-MeO—C₆H₄—, 4-MeO—C₆H₄—, 3,5-Me₂-C₆H₃—, o-tolyl, 2,6-F₂—C₆H₃— or where R⁷ is joined together with R⁶ to form a fused ring system, e.g., quinoline.

Also optionally, two or more R⁴, R⁵, R⁶, or R⁷ groups may be joined to form a fused ring system having from 3-50 non-hydrogen atoms in addition to the pyridine ring, e.g. generating a quinoline group. In these embodiments, R³ is selected from the group consisting of aryl, substituted aryl, heteroaryl, substituted heteroaryl, primary and secondary alkyl groups, and —PY₂ where Y is selected from the group consisting of aryl, substituted aryl, heteroaryl, and substituted heteroaryl.

Optionally within above formulas (6) and (7), R⁶ and R¹⁰ may be joined to form a ring system having from 5-50 non-hydrogen atoms. For example, if R⁶ and R¹⁰ together form a methylene, the ring will have 5 atoms in the backbone of the ring, which may or may not be substituted with other atoms. Also for example, if R⁶ and R¹⁰ together form an ethylene, the ring will have 6 atoms in the backbone of the ring, which may or may not be substituted with other atoms. Substituents from the ring can be selected from the group consisting of halo, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, nitro, and combinations thereof.

In certain embodiments, the ligands are novel compounds and those of ordinary skill in the art will be able to identify such compounds from the above. One example of the novel ligand compounds, includes those compounds generally characterized by formula (5), above where R² is selected from the group consisting of hydrogen, alkyl, substituted alkyl, cycloalkyl, substituted cycloalkyl, aryl, and substituted aryl; and R³ is a phosphino characterized by the formula —PZ¹Z², where each of Z¹ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof. Particularly preferred embodiments of these compounds include those where Z¹ and Z² are each independently selected from the group consisting of alkyl, substituted alkyl, cycloalkyl, heterocycloalkyl, aryl, and substituted aryl; and more specifically phenyl; where Q¹, Q³, and Q⁵ are each selected from the group consisting of alkyl and substituted alkyl and each of Q² and Q⁴ is hydrogen; and where R⁴, R⁵, R⁶ and R⁷ are each hydrogen.

The ligands of the catalysts of this invention may be prepared using known procedures. See, for example, Advanced Organic Chemistry, March, Wiley, New York 1992 (4.sup.th, Ed.). Specifically, the ligands of the invention may be prepared using the two step procedure outlined in Schemes 1 and as disclosed at page 42 to 44 of WO 03/040201.

Compositions

Once the desired ligand is formed, it may be combined with a metal atom, ion, compound or other metal precursor compound. In some applications, the ligands of this invention will be combined with a metal compound or precursor and the product of such combination is not determined, if a product forms. For example, the ligand may be added to a reaction vessel at the same time as the metal or metal precursor compound along with the reactants, activators, scavengers, etc. Additionally, the ligand can be modified prior to addition to or after the addition of the metal precursor, e.g. through a deprotonation reaction or some other modification.

For the above formulae, the metal precursor compounds may be characterized by the general formula Hf(L)ₙ where L is independently selected from the group consisting of halide (F, Cl, Br, I), alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 1, 2, 3, 4, 5, or 6. The hafnium precursors may be monomeric, dimeric or higher orders thereof. It is well known that hafnium metal typically contains some amount of impurity of zirconium. Thus, this invention uses as pure hafnium as is commercially reasonable. Specific examples of suitable hafnium precursors include, but are not limited to HfCl₄, Hf(CH₂Ph)₄, Hf(CH₂CMe₃)₄, Hf(CH₂SiMe₃)₄, Hf(CH₂Ph)₃Cl, Hf(CH₂CMe₃)₃Cl, Hf(CH₂SiMe₃)₃Cl, Hf(CH₂Ph)₂Cl₂, Hf(CH₂CMe₃)₂Cl₂, Hf(CH₂SiMe₃)₂Cl₂, Hf(NMe₂)₄, Hf(NEt₂)₄, and Hf(N(SiMe₃)₂)₂Cl₂. Lewis base adducts of these examples are also suitable as hafnium precursors, for example, ethers, amines, thioethers, phosphines and the like are suitable as Lewis bases.

For formulae 5 and 6, the metal precursor compounds may be characterized by the general formula M(L)ₙ where M is hafnium or zirconium and each L is independently selected from the group consisting of halide (F, Cl, Br, I), alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 4, typically. It is well known that hafnium metal typically contains some amount of impurity of zirconium. Thus, this invention uses as pure hafnium or zirconium as is commercially reasonable. Specific examples of suitable hafnium and zirconium precursors include, but are not limited to HfCl₄, Hf(CH₂Ph)₄, Hf(CH₂CMe₃)₄, Hf(CH₂SiMe₃)₄, Hf(CH₂Ph)₃Cl, Hf(CH₂CMe₃)₃Cl, Hf(CH₂SiMe₃)₃Cl, Hf(CH₂Ph)₂Cl₂, Hf(CH₂CMe₃)₂Cl₂, Hf(CH₂SiMe₃)₂Cl₂, Hf(NMe₂)₄, Hf(NEt₂)₄, and Hf(N(SiMe₃)₂)₂Cl₂, ZrCl₄, Zr(CH₂Ph)₄, Zr(CH₂CMe₃)₄, Zr(CH₂SiMe₃)₄, Zr(CH₂Ph)₃Cl, Zr(CH₂CMe₃)₃Cl, Zr(CH₂SiMe₃)₃Cl, Zr(CH₂Ph)₂Cl₂, Zr(CH₂CMe₃)₂Cl₂, Zr(CH₂SiMe₃)₂Cl₂, Zr(NMe₂)₄, Zr(NEt₂)₄, and Zr(N(SiMe₃)₂)₂Cl₂.

Lewis base adducts of these examples are also suitable as hafnium precursors, for example, ethers, amines, thioethers, phosphines and the like are suitable as Lewis bases.

The ligand to metal precursor compound ratio is typically in the range of about 0.01:1 to about 100:1, more preferably in the range of about 0.1:1 to about 10:1.

Metal-Ligand Complexes

This invention, in part, relates to the use of nonmetallocene metal-ligand complexes. Generally, the ligand is mixed with a suitable metal precursor compound prior to or simultaneously with allowing the mixture to be contacted with the reactants (e.g., monomers). When the ligand is mixed with the metal precursor compound, a metal-ligand complex may be formed, which may be a catalyst or may need to be activated to be a catalyst. The metal-ligand complexes discussed herein are referred to as 2,1 complexes or 3,2 complexes, with the first number representing the number of coordinating atoms and second number representing the charge occupied on the metal. The 2,1-complexes therefore have two coordinating atoms and a single anionic charge. Other embodiments of this invention are those complexes that have a general 3,2 coordination scheme to a metal center, with 3,2 referring to a ligand that occupies three coordination sites on the metal and two of those sites being anionic and the remaining site being a neutral Lewis base type coordination.

Looking first at the 2,1-nonmetallocene metal-ligand complexes, the metal-ligand complexes may be characterized by the following general formula (8): 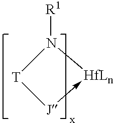
wherein T, J″, R¹, L and n are as defined previously; and x is 1 or 2. The J″ heteroaryl may or may not datively bond, but is drawn as bonding. More specifically, the nonmetallocene-ligand complexes may be characterized by the formula (9): 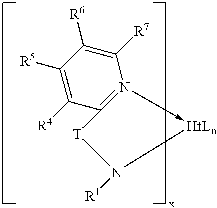
wherein R¹, T, R⁴, R⁵, R⁶, R⁷, L and n are as defined previously; and x is 1 or 2. In one preferred embodiment x=1 and n=3. Additionally, Lewis base adducts of these metal-ligand complexes are also within the scope of the invention, for example, ethers, amines, thioethers, phosphines and the like are suitable as Lewis bases.

More specifically, the nonmetallocene metal-ligand complexes of this invention may be characterized by the general formula (10): 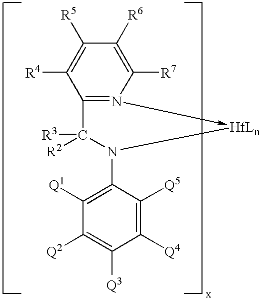
wherein the variables are generally defined above. Thus, e.g., Q², Q³, Q⁴, R², R³, R⁴, R⁵, R⁶ and R⁷ are independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, nitro, and combinations thereof, optionally, two or more R⁴, R⁵, R⁶ and R⁷ groups may be joined to form a fused ring system having from 3-50 non-hydrogen atoms in addition to the pyridine ring, e.g. generating a quinoline group; also, optionally, any combination of R², R³, and R⁴, may be joined together in a ring structure; Q¹ and Q⁵ are selected from the group consisting of alkyl, substituted alkyl, cycloalkyl, substituted cycloalkyl, aryl, substituted aryl, provided that Q¹ and Q⁵ are not both methyl; and each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates and combinations thereof; n is 1, 2, 3, 4, 5, or 6; and x=1 or 2.

In other embodiments, the 2,1 metal-ligand complexes can be characterized by the general formula (11): 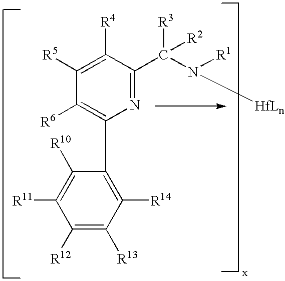
wherein the variables are generally defined above.

In still other embodiments, the 2,1 metal-ligand complexes of this invention can be characterized by the general formula (12) 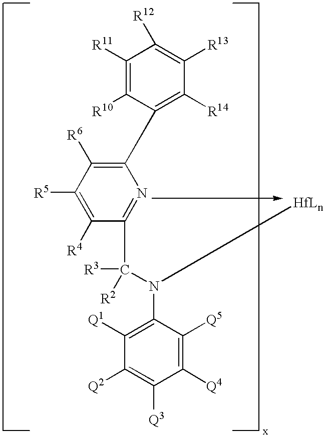
wherein the variables are generally defined above.

In a particularly preferred embodiment the nonmetallocene metal-ligand complexes are represented by the formulae at page 50-51 of WO 03/040201.

Turning to the 3,2 metal-ligand nonmetallocene complexes used in the practice of this invention, the metal-ligand complexes may be characterized by the general formula (13): 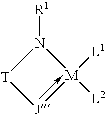
where M is zirconium or hafnium; R¹ and T are defined above; J″′ being selected from the group of substituted heteroaryls with 2 atoms bonded to the metal M, at least one of those 2 atoms being a heteroatom, and with one atom of J″′ is bonded to M via a dative bond, the other through a covalent bond; and L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof.

More specifically, the 3,2 metal-ligand nonmetallocene complexes of this invention may be characterized by the general formula (14): 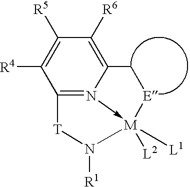
where M is zirconium or hafnium; T, R¹, R⁴, R⁵, R⁶, L¹ and L² are defined above; and E″ is either carbon or nitrogen and is part of an cyclic aryl, substituted aryl, heteroaryl, or substituted heteroaryl group.

Even more specifically, the 3,2 metal-ligand nonmetallocene complexes used in the practice of this invention may be characterized by the general formula (15): 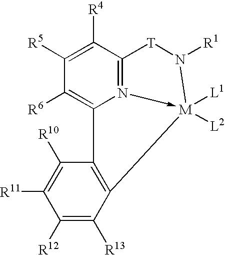
where M is zirconium or hafnium; and T, R¹, R⁴, R⁵, R⁶, R¹⁰, R¹¹, R¹², R¹³, L¹ and L² are defined above.

Still even more specifically, the 3,2 metal-ligand nonmetallocene complexes of this invention may be characterized by the general formula (16): 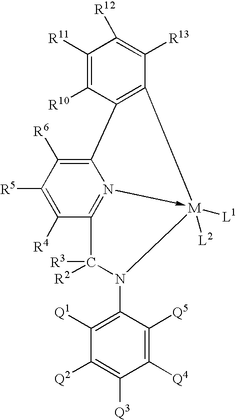
where M is zirconium or hafnium; and R², R³, R⁴, R⁵, R⁶, R¹⁰, R¹¹, R¹², R¹³, Q¹, Q², Q³, Q⁴, Q⁵, L¹ and L² are defined above.

In the above formulas, R¹⁰, R¹¹, R¹², and R¹³ are independently selected from the group consisting of hydrogen, halo, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, nitro, and combinations thereof; optionally, two or more R¹⁰, R¹¹, R¹², and R¹³ groups may be joined to form a fused ring system having from 3-50 non-hydrogen atoms.

In addition, Lewis base adducts of the metal-ligand complexes in the above formulas are also suitable, for example, ethers, amines, thioethers, phosphines and the like are suitable as Lewis bases.

The metal-ligand complexes can be formed by techniques known to those of skill in the art. In some embodiments, R¹⁴ is hydrogen and the metal-ligand complexes are formed by a metallation reaction (in situ or not) as shown in the reaction scheme on page 54-55 of WO 03/040201.

Specific examples of 3,2 complexes of this invention include all those listed in WO 03/040201.

The ligands, complexes or catalysts may be supported on an organic or inorganic support. Suitable supports include silicas, aluminas, clays, zeolites, magnesium chloride, polyethyleneglycols, polystyrenes, polyesters, polyamides, peptides and the like. Polymeric supports may be cross-linked or not. Similarly, the ligands, complexes or catalysts may be supported on similar supports known to those of skill in the art. In addition, the catalysts of this invention may be combined with other catalysts in a single reactor and/or employed in a series of reactors (parallel or serial) in order to form blends of polymer products. Supported catalysts typically produce copolymers of this invention with an MWD larger than those produce from unsupported catalysts, although these MWDs are typically less about 6, preferably less than about 5 and more preferably less than about 4. While not wanting to be bound by any particular theory of operation, the unsupported catalysts typically produce P/E* polymers with a narrow MWD which suggests that the nonmetallocene, metal-centered, heteroaryl ligand catalysts used in the practice of this invention are “single-site” catalysts.

The metal complexes used in this invention are rendered catalytically active by combination with an activating cocatalyst or by use of an activating technique. Suitable activating cocatalysts for use herein include neutral Lewis acids such as alumoxane (modified and unmodified), C1-C30 hydrocarbyl substituted Group 13 compounds, especially tri(hydrocarbyl)aluminum- or tri(hydrocarbyl)boron compounds and halogenated (including perhalogenated) derivatives thereof, having from 1 to 10 carbons in each hydrocarbyl or halogenated hydrocarbyl group, more especially perfluorinated tri(aryl)boron compounds, and most especially tris(pentafluorophenyl)borane; nonpolymeric, compatible, noncoordinating, ion forming compounds (including the use of such compounds under oxidizing conditions), especially the use of ammonium-, phosphonium-, oxonium-, carbonium-, silylium- or sulfonium-salts of compatible, noncoordinating anions, or ferrocenium salts of compatible, noncoordinating anions; bulk electrolysis (explained in more detail hereinafter); and combinations of the foregoing activating cocatalysts and techniques. The foregoing activating cocatalysts and activating techniques have been previously taught with respect to different metal complexes in the following references: U.S. Pat. No. 5,153,157 and U.S. Pat. No. 5,064,802, EP-A-277,003, EP-A-468,651 (equivalent to U.S. Ser. No. 07/547,718), U.S. Pat. No. 5,721,185 and U.S. Pat. No. 5,350,723.

The alumoxane used as an activating cocatalyst in this invention is of the formula (R⁴ₓ(CH₃)_{y}AlOₙ, in which R⁴ is a linear, branched or cyclic C1 to C6 hydrocarbyl, x is from 0 to about 1, y is from about 1 to 0, and n is an integer from about 3 to about 25, inclusive. The preferred alumoxane components, referred to as modified methylaluminoxanes, are those wherein R⁴ is a linear, branched or cyclic C3 to C9 hydrocarbyl, x is from about 0.15 to about 0.50, y is from about 0.85 to about 0.5 and n is an integer between 4 and 20, inclusive; still more preferably, R⁴ is isobutyl, tertiary butyl or n-octyl, x is from about 0.2 to about 0.4, y is from about 0.8 to about 0.6 and n is an integer between 4 and 15, inclusive. Mixtures of the above alumoxanes may also be employed in the practice of the invention.

Most preferably, the alumoxane is of the formula (R⁴ₓ(CH₃)._{y}AlO)ₙ, wherein R⁴ is isobutyl or tertiary butyl, x is about 0.25, y is about 0.75 and n is from about 6 to about 8.

Particularly preferred alumoxanes are so-called modified alumoxanes, preferably modified methylalumoxanes (MMAO), that are completely soluble in alkane solvents, for example heptane, and may include very little, if any, trialkylaluminum. A technique for preparing such modified alumoxanes is disclosed in U.S. Pat. No. 5,041,584 (which is incorporated by reference). Alumoxanes useful as an activating cocatalyst in this invention may also be made as disclosed in U.S. Pat. Nos. 4,542,199; 4,544,762; 4,960,878; 5,015,749; 5,041,583 and 5,041,585. Various alumoxanes can be obtained from commercial sources, for example, Akzo-Nobel Corporation, and include MMAO-3A, MMAO-12, and PMAO-IP.

Combinations of neutral Lewis acids, especially the combination of a trialkyl aluminum compound having from 1 to 4 carbons in each alkyl group and a halogenated tri(hydrocarbyl)boron compound having from 1 to 10 carbons in each hydrocarbyl group, especially tris(pentafluorophenyl)b-orane, and combinations of neutral Lewis acids, especially tris(pentafluorophenyl)borane, with nonpolymeric, compatible noncoordinating ion-forming compounds are also useful activating cocatalysts.

Suitable ion forming compounds useful as cocatalysts in one embodiment of the present invention comprise a cation which is a Bronsted acid capable of donating a proton, and a compatible, noncoordinating anion, A⁻. As used herein, the term “noncoordinating” means an anion or substance which either does not coordinate to the Group 4 metal containing precursor complex and the catalytic derivative derived therefrom, or which is only weakly coordinated to such complexes thereby remaining sufficiently labile to be displaced by a neutral Lewis base. A noncoordinating anion specifically refers to an anion which when functioning as a charge balancing anion in a cationic metal complex does not transfer an anionic substituent or fragment thereof to said cation thereby forming neutral complexes. “Compatible anions” are anions which are not degraded to neutrality when the initially formed complex decomposes and are noninterfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, said anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions which comprise coordination complexes containing a single metal or metalloid atom are, of course, well known and many, particularly such compounds containing a single boron atom in the anion portion, are available commercially.

In one embodiment of this invention, the activating cocatalysts may be represented by the following general formula: [L*−H]⁺_{d}[A^{d-}] wherein: L* is a neutral Lewis base; [L*−H]⁺ is a Bronsted acid; A^{d-} is a noncoordinating, compatible anion having a charge of d⁻; and d is an integer from 1 to 3. More preferably A^{d-} corresponds to the formula: [M′^{k+}Qₙ′]^{d-} wherein: k is an integer from 1 to 3; n′ is an integer from 2 to 6; n′−k=d; M′ is an element selected from Group 13 of the Periodic Table of the Elements; and each Q is independently selected from hydride, dialkylamido, halide, hydrocarbyl, hydrocarbyloxy, halosubstituted-hydrocarbyl, halosubstituted hydrocarbyloxy, and halo substituted silylhydrocarbyl radicals (including perhalogenated hydrocarbyl-perhalogenated hydrocarbyloxy- and perhalogenated silylhydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, i.e., the counter ion has a single negative charge and is A⁻. Activating cocatalysts comprising boron which are particularly useful in the preparation of catalysts of this invention may be represented by the following general formula: [L*−H]⁺[BQ₄]⁻ wherein: [L*−H]⁺ is as previously defined; B is boron in an oxidation state of 3; and Q is a hydrocarbyl-, hydrocarbyloxy-, fluorinated hydrocarbyl-, fluorinated hydrocarbyloxy- or fluorinated silylhydrocarbyl-group of up to 20 nonhydrogen atoms, with the proviso that in not more than one occasion is Q hydrocarbyl. Most preferably, Q is each occurrence a fluorinated aryl group, especially, a pentafluorophenyl group.

Illustrative, but not limiting, examples of boron compounds which may be used as an activating cocatalyst in the preparation of the catalysts of this invention are tri-substituted ammonium salts such as:
triethylammonium tetraphenylborate, N,N-dimethylanilinium tetraphenylborate, tripropylammonium tetrakis(pentafluorophenyl)borate, N,N-dimethylanilinium n-butyltris(pentafluorophenyl)borate, triethylammonium tetrakis(2,3,4,6-tetrafluorophenyl)borate, N,N-diethylanilinium tetrakis(2,3,4,6-tetrafluorophenyl)borate, and N,N-dimethyl-2,4,6-trimethylanilinium tetrakis(2,3,4,6-tetrafluorop-henyl)borate;
   dialkyl ammonium salts such as:
di-(i-propyl)ammonium tetrakis(pentafluorophenyl)borate, and dicyclohexylammonium tetrakis(pentafluorophenyl)borate;
   tri-substituted phosphonium salts such as:
triphenylphosphonium tetrakis(pentafluorophenyl)borate, tri(o-tolyl)phosphonium tetrakis(pentafluorophenyl)borate, and tri(2,6-dimethylphenyl)phosphonium tetrakis(pentafluorophenyl)borate;
   di-substituted oxonium salts such as:
diphenyloxonium tetrakis(pentafluorophenyl)borate, di(o-tolyl)oxonium tetrakis(pentafluorophenyl)borate, and di(2,6-dimethylphenyl)oxonium tetrakis(pentafluorophenyl)borate;
   di-substituted sulfonium salts such as:
diphenylsulfonium tetrakis(pentafluorophenyl)borate, di(o-tolyl)sulfonium tetrakis(pentafluorophenyl)borate, and di(2,6-dimethylphenyl)sulfonium tetrakis(pentafluorophenyl)borate.

Preferred [L*−H]⁺ cations include N,N-dimethylanilinium and tributylammonium.

Another suitable ion forming, activating cocatalyst comprises a salt of a cationic oxidizing agent and a noncoordinating, compatible anion represented by the formula: (Ox.^{e+})_{d}(A^{d-})ₑ wherein: Ox.^{e+} is a cationic oxidizing agent having a charge of e⁺; e is an integer from 1 to 3; and A^{d-} and d are as previously defined.

Examples of cationic oxidizing agents include: ferrocenium, hydrocarbyl-substituted ferrocenium, Ag⁺, or Pb⁺². Preferred embodiments of A^{d-} are those anions previously defined with respect to the Bronsted acid containing activating cocatalysts, especially tetrakis(pentafluorophenyl)borate.

Another suitable ion forming, activating cocatalyst comprises a compound which is a salt of a carbenium ion and a noncoordinating, compatible anion represented by the formula: [C]⁺A⁻ wherein: [C]⁺ is a C1-C20 carbenium ion; and A⁻ is as previously defined.

A preferred carbenium ion is the trityl cation, i.e., triphenylmethylium.

A further suitable ion forming, activating cocatalyst comprises a compound which is a salt of a silylium ion and a noncoordinating, compatible anion represented by the formula: R₃Si(X′)_{q}⁺A⁻ wherein: R is C1-C10 hydrocarbyl, and X′, q and A⁻ are as previously defined.

Preferred silylium salt activating cocatalysts are trimethylsilylium tetrakis(pentafluorophenyl)borate, triethylsilylium(tetrakispentafluoro)phenylborate and ether substituted adducts thereof. Silylium salts have been previously generically disclosed in J. Chem. Soc. Chem. Comm., 1993, 383-384, as well as Lambert, J. B., et al., Organometallics, 1994, 13, 2430-2443.

Certain complexes of alcohols, mercaptans, silanols, and oximes with tris(pentafluorophenyl)borane are also effective catalyst activators and may be used according to the present invention. Such cocatalysts are disclosed in U.S. Pat. No. 5,296,433.

The technique of bulk electrolysis involves the electrochemical oxidation of the metal complex under electrolysis conditions in the presence of a supporting electrolyte comprising a noncoordinating, inert anion. In the technique, solvents, supporting electrolytes and electrolytic potentials for the electrolysis are used such that electrolysis byproducts that would render the metal complex catalytically inactive are not substantially formed during the reaction. More particularly, suitable solvents are materials that are: liquids under the conditions of the electrolysis (generally temperatures from 0 to 100° C.), capable of dissolving the supporting electrolyte, and inert. “Inert solvents” are those that are not reduced or oxidized under the reaction conditions employed for the electrolysis. It is generally possible in view of the desired electrolysis reaction to choose a solvent and a supporting electrolyte that are unaffected by the electrical potential used for the desired electrolysis. Preferred solvents include difluorobenzene (all isomers), dimethoxyethane (DME), and mixtures thereof.

The electrolysis may be conducted in a standard electrolytic cell containing an anode and cathode (also referred to as the working electrode and counter electrode respectively). Suitable materials of construction for the cell are glass, plastic, ceramic and glass coated metal. The electrodes are prepared from inert conductive materials, by which are meant conductive materials that are unaffected by the reaction mixture or reaction conditions. Platinum or palladium are preferred inert conductive materials. Normally an ion permeable membrane such as a fine glass frit separates the cell into separate compartments, the working electrode compartment and counter electrode compartment. The working electrode is immersed in a reaction medium comprising the metal complex to be activated, solvent, supporting electrolyte, and any other materials desired for moderating the electrolysis or stabilizing the resulting complex. The counter electrode is immersed in a mixture of the solvent and supporting electrolyte. The desired voltage may be determined by theoretical calculations or experimentally by sweeping the cell using a reference electrode such as a silver electrode immersed in the cell electrolyte. The background cell current, the current draw in the absence of the desired electrolysis, is also determined. The electrolysis is completed when the current drops from the desired level to the background level. In this manner, complete conversion of the initial metal complex can be easily detected.

Suitable supporting electrolytes are salts comprising a cation and a compatible, noncoordinating anion, A⁻. Preferred supporting electrolytes are salts corresponding to the formula: G⁺A⁻ wherein: G⁺ is a cation which is nonreactive towards the starting and resulting complex, and A⁻ is as previously defined.

Examples of cations, G⁺, include tetrahydrocarbyl substituted ammonium or phosphonium cations having up to 40 nonhydrogen atoms. Preferred cations are the tetra-n-butylammonium- and tetraethylammonium-cations.

During activation of the complexes of the present invention by bulk electrolysis the cation of the supporting electrolyte passes to the counter electrode and A⁻ migrates to the working electrode to become the anion of the resulting oxidized product. Either the solvent or the cation of the supporting electrolyte is reduced at the counter electrode in equal molar quantity with the amount of oxidized metal complex formed at the working electrode. Preferred supporting electrolytes are tetrahydrocarbylammonium salts of tetrakis(perfluoroaryl)borates having from 1 to 10 carbons in each hydrocarbyl or perfluoroaryl group, especially tetra-n-butylammonium tetrakis(pentafluorophenyl)borate.

A further electrochemical technique for generation of activating cocatalysts is the electrolysis of a disilane compound in the presence of a source of a noncoordinating compatible anion. This technique is more fully disclosed and claimed in U.S. Pat. No. 5,625,087.

The foregoing activating techniques and ion forming cocatalysts are also preferably used in combination with a tri(hydrocarbyl)aluminum or tri(hydrocarbyl)borane compound having from 1 to 4 carbons in each hydrocarbyl group.

In a preferred embodiment, the activator is selected from the group consisting of:
trimethyl ammonium tetraphenylborate, triethylammonium tetraphenylborate, tripropylammonium tetraphenylborate, tri(n-butyl)ammonium tetraphenylborate, tri(tert-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium) tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluorophenyl)borate, dimethyl(tert-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium)tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(tert-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium) tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(tert-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium) tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(tert-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium) tetrakis(3,5-bis(trifluoromethyl)phenyl)borate, di-(iso-propyl)ammonium tetrakis(pentafluorophenyl)borate, dicyclohexylammonium tetrakis(pentafluorophenyl)borate; tri(o-tolyl)phosphonium tetrakis(pentafluorophenyl)borate, tri(2,6-dimethylphenyl)phosphonium tetrakis(pentafluorophenyl)borate, tropillium tetraphenylborate, triphenylcarbenium tetraphenylborate, triphenylphosphonium tetraphenylborate, triethylsilylium tetraphenylborate, benzene(diazonium)tetraphenylborate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium)tetrakis-(2,3,4,6-tetrafluorophenyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, and benzene(diazonium)tetrakis(3,5-bis(trifluoromethyl)phenyl)borate.

The molar ratio of catalyst/cocatalyst employed preferably ranges from 1:10,000 to 100:1, more preferably from 1:5000 to 10:1, most preferably from 1:100 to 1:1. In one embodiment of the invention the cocatalyst can be used in combination with a tri(hydrocarbyl)aluminum compound having from 1 to 10 carbons in each hydrocarbyl group. Mixtures of activating cocatalysts may also be employed. It is possible to employ these aluminum compounds for their beneficial ability to scavenge impurities such as oxygen, water, and aldehydes from the polymerization mixture. Preferred aluminum compounds include trialkyl aluminum compounds having from 1 to 6 carbons in each alkyl group, especially those wherein the alkyl groups are methyl, ethyl, propyl, isopropyl, n-butyl, isobutyl, pentyl, neopentyl or isopentyl. The molar ratio of metal complex to aluminum compound is preferably from 1:10,000 to 100:1, more preferably from 1:1000 to 10:1, most preferably from 1:500 to 1:1. A most preferred borane activating cocatalyst comprises a strong Lewis acid, especially tris(pentafluorophenyl)borane.

In some embodiments disclosed herein, two or more different catalysts, including the use of mixed catalysts can be employed. In addition to a nonmetallocene, metal-centered, heteroaryl ligand catalyst, when a plurality of catalysts are used, any catalyst which is capable of copolymerizing one or more olefin monomers to make an interpolymer or homopolymer may be used in embodiments of the invention in conjunction with a nonmetallocene, metal-centered, heteroaryl ligand catalyst. For certain embodiments, additional selection criteria, such as molecular weight capability and/or comonomer incorporation capability, preferably should be satisfied. Two or more nonmetallocene, metal-centered, heteroaryl ligand catalysts having different substituents can be used in the practice of certain of the embodiments disclosed herein. Suitable catalysts which may be used in conjunction with the nonmetallocene, metal-centered, heteroaryl ligand catalysts disclosed herein include, but are not limited to, metallocene catalysts and constrained geometry catalysts, multi-site catalysts (Ziegler-Natta catalysts), and variations therefrom. They include any known and presently unknown catalysts for olefin polymerization. It should be understood that the term “catalyst” as used herein refers to a metal-containing compound which is used, along with an activating cocatalyst, to form a catalyst system. The catalyst, as used herein, is usually catalytically inactive in the absence of a cocatalyst or other activating technique. However, not all suitable catalysts are catalytically inactive without a cocatalyst

One suitable class of catalysts is the constrained geometry catalysts disclosed in U.S. Pat. No. 5,064,802, U.S. Pat. No. 5,132,380, U.S. Pat. No. 5,703,187, U.S. Pat. No. 6,034,021, EP 0 468 651, EP 0 514 828, WO 93/19104, and WO 95/00526, all of which are incorporated by references herein in their entirety. Another suitable class of catalysts is the metallocene catalysts disclosed in U.S. Pat. No. 5,044,438; U.S. Pat. No. 5,057,475; U.S. Pat. No. 5,096,867; and U.S. Pat. No. 5,324,800, all of which are incorporated by reference herein in their entirety. It is noted that constrained geometry catalysts may be considered as metallocene catalysts, and both are sometimes referred to in the art as single-site catalysts.

Another suitable class of catalysts is substituted indenyl containing metal complexes as disclosed in U.S. Pat. No. 5,965,756 and U.S. Pat. No. 6,015,868 which are incorporated by reference herein in their entirety. Other catalysts are disclosed in copending applications: U.S. application Ser. No. 09/230,185; and Ser. No. 09/715,380, and U.S. Provisional Application Ser. No. 60/215,456; No. 60/170,175, and No. 60/393,862. The disclosures of all of the preceding patent applications are incorporated by reference herein in their entirety. These catalysts tend to have a higher molecular weight capability.

Other catalysts, cocatalysts, catalyst systems, and activating techniques which may be used in the practice of the invention disclosed herein may include those disclosed in WO 96/23010, published on Aug. 1, 1996, the entire disclosure of which is hereby incorporated by reference; those disclosed in WO 99/14250, published Mar. 25, 1999, the entire disclosure of which is hereby incorporated by reference; those disclosed in WO 98/41529, published Sep. 24, 1998, the entire disclosure of which is hereby incorporated by reference; those disclosed in WO 97/42241, published Nov. 13, 1997, the entire disclosure of which is hereby incorporated by reference; those disclosed by Scollard, et al., in J. Am. Chem. Soc 1996, 118, 10008-10009, the entire disclosure of which is hereby incorporated by reference; those disclosed in EP 0 468 537 B1, published Nov. 13, 1996, the entire disclosure of which is hereby incorporated by reference; those disclosed in WO 97/22635, published Jun. 26, 1997, the entire disclosure of which is hereby incorporated by reference; those disclosed in EP 0 949 278 A2, published Oct. 13, 1999, the entire disclosure of which is hereby incorporated by reference; those disclosed in EP 0 949 279 A2, published Oct. 13, 1999, the entire disclosure of which is hereby incorporated by reference; those disclosed in EP 1 063 244 A2, published Dec. 27, 2000, the entire disclosure of which is hereby incorporated by reference; those disclosed in U.S. Pat. No. 5,408,017, the entire disclosure of which is hereby incorporated by reference; those disclosed in U.S. Pat. No. 5,767,208, the entire disclosure of which is hereby incorporated by reference; those disclosed in U.S. Pat. No. 5,907,021, the entire disclosure of which is hereby incorporated by reference; those disclosed in WO 88/05792, published Aug. 11, 1988, the entire disclosure of which is hereby incorporated by reference; those disclosed in WO88/05793, published Aug. 11, 1988, the entire disclosure of which is hereby incorporated by reference; those disclosed in WO 93/25590, published Dec. 23, 1993, the entire disclosure of which is hereby incorporated by reference; those disclosed in U.S. Pat. No. 5,599,761, the entire disclosure of which is hereby incorporated by reference; those disclosed in U.S. Pat. No. 5,218,071, the entire disclosure of which is hereby incorporated by reference; those disclosed in WO 90/07526, published Jul. 12, 1990, the entire disclosure of which is hereby incorporated by reference; those disclosed in U.S. Pat. No. 5,972,822, the entire disclosure of which is hereby incorporated by reference; those disclosed in U.S. Pat. No. 6,074,977, the entire disclosure of which is hereby incorporated by reference; those disclosed in U.S. Pat. No. 6,013,819, the entire disclosure of which is hereby incorporated by reference; those disclosed in U.S. Pat. No. 5,296,433, the entire disclosure of which is hereby incorporated by reference; those disclosed in U.S. Pat. No. 4,874,880, the entire disclosure of which is hereby incorporated by reference; those disclosed in U.S. Pat. No. 5,198,401, the entire disclosure of which is hereby incorporated by reference; those disclosed in U.S. Pat. No. 5,621,127, the entire disclosure of which is hereby incorporated by reference; those disclosed in U.S. Pat. No. 5,703,257, the entire disclosure of which is hereby incorporated by reference; those disclosed in U.S. Pat. No. 5,728,855, the entire disclosure of which is hereby incorporated by reference; those disclosed in U.S. Pat. No. 5,731,253, the entire disclosure of which is hereby incorporated by reference; those disclosed in U.S. Pat. No. 5,710,224, the entire disclosure of which is hereby incorporated by reference; those disclosed in U.S. Pat. No. 5,883,204, the entire disclosure of which is hereby incorporated by reference; those disclosed in U.S. Pat. No. 5,504,049, the entire disclosure of which is hereby incorporated by reference; those disclosed in U.S. Pat. No. 5,962,714, the entire disclosure of which is hereby incorporated by reference; those disclosed in U.S. Pat. No. 5,965,677, the entire disclosure of which is hereby incorporated by reference; those disclosed in U.S. Pat. No. 5,427,991, the entire disclosure of which is hereby incorporated by reference; those disclosed in WO 93/21238, published Oct. 28, 1993, the entire disclosure of which is hereby incorporated by reference; those disclosed in WO 94/03506, published Feb. 17, 1994, the entire disclosure of which is hereby incorporated by reference; those disclosed in WO 93/21242, published Oct. 28, 1993, the entire disclosure of which is hereby incorporated by reference; those disclosed in WO 94/00500, published Jan. 6, 1994, the entire disclosure of which is hereby incorporated by reference; those disclosed in WO 96/00244, published Jan. 4, 1996, the entire disclosure of which is hereby incorporated by reference; those disclosed in WO 98/50392, published Nov. 12, 1998, the entire disclosure of which is hereby incorporated by reference; those disclosed in Wang, et al., Organometallics 1998, 17, 3149-3151, the entire disclosure of which is hereby incorporated by reference; those disclosed in Younkin, et al., Science 2000, 287, 460-462, the entire disclosure of which is hereby incorporated by reference; those disclosed by Chen and Marks, Chem. Rev. 2000, 100, 1391-1434, the entire disclosure of which is hereby incorporated by reference; those disclosed by Alt and Koppl, Chem. Rev. 2000, 100, 1205-1221, the entire disclosure of which is hereby incorporated by reference; those disclosed by Resconi, et al., Chem. Rev. 2000, 100, 1253-1345, the entire disclosure of which is hereby incorporated by reference; those disclosed by Ittel, et al., Chem. Rev. 2000, 100, 1169-1203, the entire disclosure of which is hereby incorporated by reference; those disclosed by Coates, Chem. Rev., 2000, 100, 1223-1251, the entire disclosure of which is hereby incorporated by reference; those disclosed by Brady, III, et al., U.S. Pat. No. 5,093,415, the entire disclosure of which is hereby incorporated by reference, those disclosed by Murray, et al., U.S. Pat. No. 6,303,719, the entire disclosure of which is hereby incorporated by reference, those disclosed by Saito, et al., U.S. Pat. No. 5,874,505, the entire disclosure of which is hereby incorporated by reference; and those disclosed in WO 96/13530, published May 9, 1996, the entire disclosure of which is hereby incorporated by reference. Also useful are those catalysts, cocatalysts, and catalyst systems disclosed in U.S. Ser. No. 09/230,185, filed Jan. 15, 1999; U.S. Pat. No. 5,965,756; U.S. Pat. No. 6,150,297; U.S. Ser. No. 09/715,380, filed Nov. 17, 2000.

Process Descriptions

In one embodiment, the process reagents, i.e., (i) propylene, (ii) ethylene and/or one or more unsaturated comonomers, (iii) catalyst, and, (iv) optionally, solvent and/or a molecular weight regulator (e.g., hydrogen), are fed to a single reaction vessel of any suitable design, e.g., stirred tank, loop, fluidized-bed, etc. The process reagents are contacted within the reaction vessel under appropriate conditions (e.g., solution, slurry, gas phase, suspension, high pressure) to form the desired polymer, and then the output of the reactor is recovered for post-reaction processing. All of the output from the reactor can be recovered at one time (as in the case of a single pass or batch reactor), or it can be recovered in the form of a bleed stream which forms only a part, typically a minor part, of the reaction mass (as in the case of a continuous process reactor in which an output stream is bled from the reactor at the same rate at which reagents are added to maintain the polymerization at steady-state conditions). “Reaction mass” means the contents within a reactor, typically during or subsequent to polymerization. The reaction mass includes reactants, solvent (if any), catalyst, and products and by-products. The recovered solvent and unreacted monomers can be recycled back to the reaction vessel.

The polymerization conditions at which the reactor is operated are similar to those for the polymerization of propylene using a known, conventional Ziegler-Natta catalyst. Typically, solution polymerization of propylene is performed at a polymerization temperature between about −50 to about 200° C., preferably between about −10 and about 150° C., and more preferably between about 20 to about 150° C. and most preferably between about 80 and 150° C., and the polymerization pressure is typically between about atmospheric to about 7, preferably between about 0.2 and about 5 MPa. In another embodiment, the polymerization temperature is above room temperature (23° C.), preferably above 30° C., preferably above 50° C., preferably above 70° C. If hydrogen is present, then it is usually present at a partial pressure (as measured in the gas phase portion of the polymerization) of about 0.1 kPa to about 5 MPa, preferably between about 1 kPa to about 3 MPa. Gas phase, suspension and other polymerization schemes will use conditions conventional for those schemes. For gas-phase or slurry-phase polymerization processes, it is desirable to perform the polymerization at a temperature below the melting point of the polymer.

In a preferred embodiment, the fluorocarbons are present in the polymerization media at 1 to 99 volume %, based upon the volume of the media, preferably the fluorocarbons are present at 5 to 99 volume %, preferably 10 to 90 volume %, preferably 20 to 80 more preferably at 20 to 60 volume %, more preferably 30 to 50 volume %. For purposes of this invention and the claims thereto polymerization media means the mixture of polymer produced, solvent/diluent and unreacted monomers. In a preferred embodiment, the fluorocarbons are present in the polymerization effluent at 0.5 to 99 volume %, based upon the volume of the effluent, preferably the fluorocarbons are present at 5 to 99 volume %, preferably 10 to 90 volume %, preferably 15 to 80 volume %, more preferably at 20 to 70 volume %, more preferably 20 to 50 volume %. For purposes of this invention and the claims thereto polymerization effluent means the mixture of unreacted monomers, solvent/diluent, polymers produced exiting the reactor. The fluorocarbon may be added before, during or after the polymerization. Likewise the fluorocarbon may be added at the reactor exit or during recovery processes after the polymer has exited the reactor. Likewise the fluorocarbon may be added to the reactor as part of the monomer stream, the catalyst feed or with any other component, or may be added alone. In another embodiment the polymerization process is conducted without fluorocarbon present and the fluorocarbon is added to the polymerization effluent after the polymerization reaction has stopped. In another embodiment the polymerization process is conducted without fluorocarbon present and the fluorocarbon is added to the polymerization effluent after the polymerization effluent has exited the reactor. In another embodiment the polymerization process is conducted in the presence of fluorocarbon and additional fluorocarbon (which may be the same or different from the first fluorocarbon) is added to the polymerization effluent after the polymerization reaction has exited the reactor and or the polymerization reaction has stopped.

One aspect of this invention relates in part to a solution process for polymerization using fluorinated hydrocarbon(s) or a mixture of fluorinated hydrocarbons and hydrocarbon solvents to provide a means of increasing polymer solute concentration and/or reducing viscosity of polymerization medium without polymer precipitation. Without wishing to be bound by any theory, we believe that a one can select one or more fluorocarbons to add in controlled amounts to the hydrocarbon polymer solution such that the medium remains single phase, e.g. homogeneous, and or that the interaction effect between the fluorinated hydrocarbon and the dissolved polymer somehow contributes to causing the polymer chain to coil up partially thereby decreasing the potential polymer-polymer entanglements and thus decreasing the solution viscosity.

In another aspect of the invention the polymerization occurs in a solution phase process where the fluorocarbon is present in a smaller amount, such as 0.5 to 20 volume %, preferably 5 to 15 volume %) where the effect of the fluorocarbon is to increase the amount of polymer solute in a polymerization medium or effluent and or reduce the viscosity of the polymerization medium or effluent. Preferred processes include introducing a fluorocarbon into the polymerization medium or effluent in an amount effective to increase the amount of polymer solute in the polymerization medium or effluent by at least 3% without causing precipitation of polymer solute from the polymerization medium or effluent or introducing a fluorocarbon into the polymerization medium or effluent in an amount effective to reduce the viscosity of the polymerization medium or effluent by at least 3% without causing precipitation of polymer solute from the polymerization medium or effluent, as compared to the same polymerization medium or effluent without the fluorocarbon present. Additionally preferred processes include introducing a fluorocarbon into the polymerization medium or effluent in an amount effective to increase the amount of polymer solute present by at least 1%, and reduce the viscosity of the polymerization medium or effluent by at least 3% without causing precipitation of polymer solute from the polymerization medium or effluent, as compared to the same polymerization medium or effluent without the fluorocarbon present.

In a preferred embodiment, one or more fluorocarbons are added to a polymerization process in a polymerization reactor in an amount effective to reduce the viscosity of the polymerization media or effluent by at least 5%, preferably by at least 10%, more preferably at least 15%, more preferably at least 20% as compared to the exact same polymerization media or effluent without the fluorocarbon. The viscosity of the polymerization medium or the effluent is measured using a rotational viscometer developed by Geerissen, H., F. Gernandt, B. A. Wolf, and H. Lentz (“Pressure dependence of viscometric relaxation times measured with a new apparatus—WLF behavior of moderately concentrated solutions of poly(n-butylmethacrylate)s in 2-propanol,” Makromol. Chem. 192, 165-176, 1991). The apparatus consists of a measuring head and a high-pressure cell which is designed for maximum pressure of 320 MPa. The cylindrical mantle has a height of 150 mm and an outside diameter of 100 mm. The main part contains a rotor that can be moved in a coaxial stator. The stator has an inside diameter of 35.24 mm and is fixed in a holder. The height of the rotor is 58 mm, and the outside diameter is 35.05 mm. The high-pressure cell is sealed by a O-ring placed between the holder and the outside mantle. To drive the rotor, a measuring head is arranged above the cell. A motor at its top generates torque which is transmitted to the lower cylinder via a shaft. The cylinder contains permanent magnets that have counterparts inside the rotor. Through the antimagnetic holder rotational movement is transferred. The maximum shear stress achievable without slippage of the magnetic coupling is 420 Pa. The polymer sample is first dissolved in a solvent at a given concentration, and the polymer solution is homogenized in an autoclave reactor. After homogenizing the polymer solution, it is fed into an electrically heated viscometer via a short high-pressure tube. The preset pressure is then adjusted by a metal bellows arranged inside the autoclave. The viscometer is controlled by a computer. Additional torque due to viscous flow of the polymer solution is transmitted to the measuring head and causes drilling of the spring. The angle of drilling is used to determine the torque from which the dynamic viscosity is calculated.

In another embodiment, this invention relates to a method to increase the amount of polymer solute present in a polymerization medium or a polymerization effluent by at least 3% (preferably by at least 5%, more preferably by at least 7%, more preferably by at least 10%, more preferably by at least 15%, more preferably by at least 20%) by introducing a fluorocarbon into the polymerization media or effluent in an amount effective to increase the amount of polymer solute without causing precipitation of the polymer solute, as compared to the exact same medium or effluent without the fluorocarbon. The amount of polymer solute present in a polymerization medium or effluent at a given temperature is determined by separation of the polymer from volatiles in a laboratory evaporation experiment on a small sample of the reaction medium. The testing procedure is described as follows: A small amount (100 ml) of polymerization medium is sampled under the reaction condition into a stainless steel vessel of known weight. The sample vessel is then weighed to obtain the amount of polymerization medium sampled. The sample is discharged into an open container placed in a hood to evaporate the solvent and unreacted monomer. The separated polymer is further dried in a vacuum oven at 90° C. for about 12 hours. The vacuum oven dried samples is weighed to obtain the amount of polymer in the polymer solute. The weight % polymer solute present=[(the weight of the dry polymer)/(the weight of the reaction medium)]×100.

In a preferred embodiment the fluorocarbons are added in an amount effective to increase the polymer solute present in a polymerization media or a polymerization effluent by 1 to 50%, preferably by 3 to 45%, more preferably by 5 to 40%, more preferably by 10 to 35%, more preferably by 15 to 30%, more preferably by 20 to 30% without causing precipitation of the polymer solute, as compared to the exact same media or effluent without the fluorocarbon and or in an amount effective to reduce the viscosity of the media or effluent by at least 5%, preferably by at least 10%, more preferably at least 15%, more preferably at least 20% without causing precipitation of the polymer solute, as compared to the exact same media or effluent without the fluorocarbon.

By the phrase “without causing precipitation of the polymer solute” is meant that the fluorocarbon does not cause precipitation of polymer out of solution or if it does cause a minor amount of precipitation, that it is insignificant enough to not cause fouling in the selected reactor system. In particular the phrase “without causing precipitation of the polymer solute” means that the fluorocarbon does not cause precipitation of more than 1 weight % polymer out of solution, preferably that the fluorocarbon does not cause precipitation of more than 0.5 weight % polymer out of solution, preferably that the fluorocarbon does not cause precipitation of more than 0.1 weight % polymer out of solution, preferably that the fluorocarbon does not cause precipitation of more than 0.01 weight % polymer out of solution, preferably that the fluorocarbon does not cause precipitation of more than 0.001 weight % polymer out of solution. Amount of polymer (weight %) precipitate present in a polymerization media or effluent is determined by measuring the intensity of a transmitted light of the polymer solution at polymerization reaction condition. Presence of polymer precipitates causes light intensity decay. The ratio of light intensity transmitted through polymerization medium with presence of polymer precipitates to the light intensity transmitted through the polymerization medium without polymer precipitate is correlated to the concentration of polymer precipitates in the reaction medium.

In another embodiment the fluorocarbon is present in an amount effective to cause precipitation of the polymer product out of the polymerization medium or effluent. In such a process the fluorocarbon is used to increase the solids content of the polymerization medium. Such a system, where the polymer is formed and then separates into a second phase as a solid is generally considered a “slurry” system. Thus the catalyst systems described herein can be used in a slurry process to produce the polymers described herein. Typically one would expect the slurry production of such polymers having elastomeric like properties to foul in slurry like conditions. However the use of the fluorocarbons as all or part of the polymerization medium, minimizes and or eliminates this problem. Thus in a preferred embodiment, the fluorocarbon is present in an amount effective to cause precipitation of at least 1 weight % of the polymer produced, preferably at least 2 weight %, preferably at least 5 weight %, preferably at least 95 weight %. In such processes the polymer is preferably present in the slurry at a solids content of 5 to 50 weight %, based upon the weight of the solvent/diluent, unreacted monomers and polymer product, preferably at 10 to 45 weight %, preferably 15 to 40 weight %, preferably 20 to 40 weight %, preferably 25 to 35 weight %. Typically the fluorocarbon will be present in such processes at 10 to 99 volume %, preferably 20 to 80 volume %, preferably 30 to 60 volume %, based upon the volume of polymer, unreacted monomers and any solvent or diluent (such as a hydrofluorocarbon) present. These processes typically operate at or below the meting point (Tm) of the polymer being produced, such as at 120° C. or below, preferably between 50 and 120° C., preferably between 70 and 110° C., preferably between 80 and 100° C.

In another embodiment the process is operated at or above the melting point of the polymer being produced, typically at 100 to 300° C., preferably at 120 to 275° C., preferably 150 to 250° C. In such a process the polymer produced is in a molten state and may or may not be in a separate phase from the catalyst system and monomers. The fluorocarbon is typically present at lower amounts (such as 0.1 to 20 volume %) to facilitate increased polymer solute concentration or lower viscosity or at higher amounts (such as 10 to 99 volume %) to cause separation of the polymer into a different phase. The amount of a particular fluorocarbon present in a particular system will vary depending upon the temperature, pressure, polymer being produced and desired effect (e.g. increased solute concentration vs. increased precipitation, etc).

Preferred fluorocarbons for use in this invention include perfluorocarbons (“PFC” or “PFC's”) and or hydrofluorocarbons (“HFC” or “HFC's”), collectively referred to as “fluorinated hydrocarbons” or “fluorocarbons” (“FC” or “FC's”). Fluorocarbons are defined to be compounds consisting essentially of at least one carbon atom and at least one fluorine atom, and optionally hydrogen atom(s). A perfluorocarbon is a compound consisting essentially of carbon atom and fluorine atom, and includes for example linear branched or cyclic, C₁ to C₄₀ perfluoroalkanes. A hydrofluorocarbon is a compound consisting essentially of carbon, fluorine and hydrogen. Preferred FC's include those represented by the formula: CₓH_{y}F_{z} wherein x is an integer from 1 to 40, alternatively from 1 to 30, alternatively from 1 to 20, alternatively from 1 to 10, alternatively from 1 to 6, alternatively from 2 to 20 alternatively from 3 to 10, alternatively from 3 to 6, most preferably from 1 to 3, wherein y is an integer greater than or equal to 0 and z is an integer and at least one, more preferably, y and z are integers and at least one. In a preferred embodiment, z is 2 or more. For purposes of this invention and the claims thereto, the terms hydrofluorocarbon and fluorocarbon do not include chlorofluorocarbons.

In one embodiment, a mixture of fluorocarbons are used in the process of the invention, preferably a mixture of a perfluorinated hydrocarbon and a hydrofluorocarbon, and more preferably a mixture of a hydrofluorocarbons. In yet another embodiment, the hydrofluorocarbon is balanced or unbalanced in the number of fluorine atoms in the HFC used. In another embodiment, the fluorocarbon is not a perfluorinated hydrocarbon. In a particularly preferred embodiment, the fluorocarbon consists essentially of hydrofluorocarbons.

Non-limiting examples of fluorocarbons useful in this invention include fluoromethane; difluoromethane; trifluoromethane; fluoroethane; 1,1-difluoroethane; 1,2-difluoroethane; 1,1,1-trifluoroethane; 1,1,2-trifluoroethane; 1,1,1,2-tetrafluoroethane; 1,1,2,2-tetrafluoroethane; 1,1,1,2,2-pentafluoroethane; 1-fluoropropane; 2-fluoropropane; 1,1-difluoropropane; 1,2-difluoropropane; 1,3-difluoropropane; 2,2-difluoropropane; 1,1,1-trifluoropropane; 1,1,2-trifluoropropane; 1,1,3-trifluoropropane; 1,2,2-trifluoropropane; 1,2,3-trifluoropropane; 1,1,1,2-tetrafluoropropane; 1,1,1,3-tetrafluoropropane; 1,1,2,2-tetrafluoropropane; 1,1,2,3-tetrafluoropropane; 1,1,3,3-tetrafluoropropane; 1,2,2,3-tetrafluoropropane; 1,1,1,2,2-pentafluoropropane; 1,1,1,2,3-pentafluoropropane; 1,1,1,3,3-pentafluoropropane; 1,1,2,2,3-pentafluoropropane; 1,1,2,3,3-pentafluoropropane; 1,1,1,2,2,3-hexafluoropropane; 1,1,1,2,3,3-hexafluoropropane; 1,1,1,3,3,3-hexafluoropropane; 1,1,1,2,2,3,3-heptafluoropropane; 1,1,1,2,3,3,3-heptafluoropropane; 1-fluorobutane; 2-fluorobutane; 1,1-difluorobutane; 1,2-difluorobutane; 1,3-difluorobutane; 1,4-difluorobutane; 2,2-difluorobutane; 2,3-difluorobutane; 1,1,1-trifluorobutane; 1,1,2-trifluorobutane; 1,1,3-trifluorobutane; 1,1,4-trifluorobutane; 1,2,2-trifluorobutane; 1,2,3-trifluorobutane; 1,3,3-trifluorobutane; 2,2,3-trifluorobutane; 1,1,1,2-tetrafluorobutane; 1,1,1,3-tetrafluorobutane; 1,1,1,4-tetrafluorobutane; 1,1,2,2-tetrafluorobutane; 1,1,2,3-tetrafluorobutane; 1,1,2,4-tetrafluorobutane; 1,1,3,3-tetrafluorobutane; 1,1,3,4-tetrafluorobutane; 1,1,4,4-tetrafluorobutane; 1,2,2,3-tetrafluorobutane; 1,2,2,4-tetrafluorobutane; 1,2,3,3-tetrafluorobutane; 1,2,3,4-tetrafluorobutane; 2,2,3,3-tetrafluorobutane; 1,1,1,2,2-pentafluorobutane; 1,1,1,2,3-pentafluorobutane; 1,1,1,2,4-pentafluorobutane; 1,1,1,3,3-pentafluorobutane; 1,1,1,3,4-pentafluorobutane; 1,1,1,4,4-pentafluorobutane; 1,1,2,2,3-pentafluorobutane; 1,1,2,2,4-pentafluorobutane; 1,1,2,3,3-pentafluorobutane; 1,1,2,4,4-pentafluorobutane; 1,1,3,3,4-pentafluorobutane; 1,2,2,3,3-pentafluorobutane; 1,2,2,3,4-pentafluorobutane; 1,1,1,2,2,3-hexafluorobutane; 1,1,1,2,2,4-hexafluorobutane; 1,1,1,2,3,3-hexafluorobutane, 1,1,1,2,3,4-hexafluorobutane; 1,1,1,2,4,4-hexafluorobutane; 1,1,1,3,3,4-hexafluorobutane; 1,1,1,3,4,4-hexafluorobutane; 1,1,1,4,4,4-hexafluorobutane; 1,1,2,2,3,3-hexafluorobutane; 1,1,2,2,3,4-hexafluorobutane; 1,1,2,2,4,4-hexafluorobutane; 1,1,2,3,3,4-hexafluorobutane; 1,1,2,3,4,4-hexafluorobutane; 1,2,2,3,3,4-hexafluorobutane; 1,1,1,2,2,3,3-heptafluorobutane; 1,1,1,2,2,4,4-heptafluorobutane; 1,1,1,2,2,3,4-heptafluorobutane; 1,1,1,2,3,3,4-heptafluorobutane; 1,1,1,2,3,4,4-heptafluorobutane; 1,1,1,2,4,4,4-heptafluorobutane; 1,1,1,3,3,4,4-heptafluorobutane; 1,1,1,2,2,3,3,4-octafluorobutane; 1,1,1,2,2,3,4,4-octafluorobutane; 1,1,1,2,3,3,4,4-octafluorobutane; 1,1,1,2,2,4,4,4-octafluorobutane; 1,1,1,2,3,4,4,4-octafluorobutane; 1,1,1,2,2,3,3,4,4-nonafluorobutane; 1,1,1,2,2,3,4,4,4-nonafluorobutane; 1-fluoro-2-methylpropane; 1,1-difluoro-2-methylpropane; 1,3-difluoro-2-methylpropane; 1,1,1-trifluoro-2-methylpropane; 1,1,3-trifluoro-2-methylpropane; 1,3-difluoro-2-(fluoromethyl)propane; 1,1,1,3-tetrafluoro-2-methylpropane; 1,1,3,3-tetrafluoro-2-methylpropane; 1,1,3-trifluoro-2-(fluoromethyl)propane; 1,1,1,3,3-pentafluoro-2-methylpropane; 1,1,3,3-tetrafluoro-2-(fluoromethyl)propane; 1,1,1,3-tetrafluoro-2-(fluoromethyl)propane; fluorocyclobutane; 1,1-difluorocyclobutane; 1,2-difluorocyclobutane; 1,3-difluorocyclobutane; 1,1,2-trifluorocyclobutane; 1,1,3-trifluorocyclobutane; 1,2,3-trifluorocyclobutane; 1,1,2,2-tetrafluorocyclobutane; 1,1,3,3-tetrafluorocyclobutane; 1,1,2,2,3-pentafluorocyclobutane; 1,1,2,3,3-pentafluorocyclobutane; 1,1,2,2,3,3-hexafluorocyclobutane; 1,1,2,2,3,4-hexafluorocyclobutane; 1,1,2,3,3,4-hexafluorocyclobutane; 1,1,2,2,3,3,4-heptafluorocyclobutane. In addition to those fluorocarbons described herein, those fluorocarbons described in Raymond Will, et. al., CEH Marketing Report, Fluorocarbons, Pages 1-133, by the Chemical Economics Handbook-SRI International, April 2001, which is fully incorporated herein by reference, are included.

In another preferred embodiment, the fluorocarbon(s) used in the process of the invention are selected from the group consisting of difluoromethane, trifluoromethane, 1,1-difluoroethane, 1,1,1-trifluoroethane, and 1,1,1,2-tetrafluoroethane and mixtures thereof.

In one particularly preferred embodiment, the commercially available fluorocarbons useful in the process of the invention include HFC-236fa having the chemical name 1,1,1,3,3,3-hexafluoropropane, HFC-134a having the chemical name 1,1,1,2-tetrafluoroethane, HFC-245fa having the chemical name 1,1,1,3,3-Pentafluoropropane, HFC-365mfc having the chemical name 1,1,1,3,3-pentafluorobutane, R-318 having the chemical name octafluorocyclobutane, and HFC-43-10mee having the chemical name 2,3-dihydrodecafluoropentane.

In another embodiment, the fluorocarbon is not a perfluorinated C4 to C10 alkane. In another embodiment, the fluorocarbon is not perfluorodecalin, perfluoroheptane, perfluorohexane, perfluoromethylcyclohexane, perfluorooctane, perfluoro-1,3-dimethylcyclohexane, perfluorononane, fluorobenzene, or perfluorotoluene. In another embodiment the fluorocarbon is present at more than 1 weight %, based upon the weight of the fluorocarbon and any hydrocarbon solvent present in the reactor, preferably greater than 3 weight %, preferably greater than 5 weight %, preferably greater than 7 weight %, preferably greater than 10 weight %, preferably greater than 15 weight %, preferably greater than 20 weight %, preferably greater than 25 weight %, preferably greater than 30 weight %, preferably greater than 35 weight %, preferably greater than 40 weight %, preferably greater than 50 weight %, preferably greater than 55 weight %, preferably greater than 60 weight %, preferably greater than 70 weight %, preferably greater than 80 weight %, preferably greater than 90 weight %. In another embodiment the fluorocarbon is present at more than 1 weight %, based upon the weight of the fluorocarbons, monomers and any hydrocarbon solvent present in the reactor, preferably greater than 3 weight %, preferably greater than 5 weight %, preferably greater than 7 weight %, preferably greater than 10 weight %, preferably greater than 15 weight %, preferably greater than 20 weight %, preferably greater than 25 weight %, preferably greater than 30 weight %, preferably greater than 35 weight %, preferably greater than 40 weight %, preferably greater than 50 weight %, preferably greater than 55 weight %, preferably greater than 60 weight %, preferably greater than 70 weight %, preferably greater than 80 weight %, preferably greater than 90 weight %. In the event that the weight basis is not named for the weight % fluorocarbon, it shall be presumed to be based upon the total weight of the fluorocarbons, monomers and hydrocarbon solvents present in the reactor.

Preferably the fluorocarbons are present in the polymerization media at 1 to 99 volume %, based upon the volume of the media, preferably the fluorocarbons are present at 5 to 99 volume %, preferably 10 to 90 volume %, preferably 20 to 70 volume %, more preferably at 20 to 60 volume %, more preferably 30 to 50 volume %. For purposes of this invention and the claims thereto polymerization media means the mixture of solvent/diluent, polymer produced and unreacted monomers.

In another embodiment the fluorocarbon, preferably the hydrofluorocarbon, is present at more than 1 volume %, based upon the total volume of the fluorocarbon and any hydrocarbon solvent present in the reactor, preferably greater than 3 volume %, preferably greater than 5 volume %, preferably greater than 7 volume %, preferably greater than 10 volume %, preferably greater than 15 volume %, preferably greater than 20 volume %, preferably greater than 25 volume %, preferably greater than 30 volume %, preferably greater than 35 volume %, preferably greater than 40 volume %, preferably greater than 45 volume %, preferably greater than 50 volume %, preferably greater than 55 volume %, preferably greater than 60 volume %, preferably greater than 65 volume %.

In another embodiment the fluorocarbon is a blend of hydrofluorocarbon and perfluorocarbon and preferably the hydrofluorocarbon is present at more than 1 volume %, based upon the total volume of the perfluorocarbon and the hydrofluorocarbon present in the reactor, (with the balance being made up by the perfluorocarbon) preferably greater than 3 volume %, preferably greater than 5 volume %, preferably greater than 7 volume %, preferably greater than 10 volume %, preferably greater than 15 volume %, preferably greater than 20 volume %, preferably greater than 25 volume %, preferably greater than 30 volume %, preferably greater than 35 volume %, preferably greater than 40 volume %, preferably greater than 45 volume %, preferably greater than 50 volume %, preferably greater than 55 volume %, preferably greater than 60 volume %, preferably greater than 65 volume %.

In yet another embodiment, the fluorocarbons of the invention have a weight average molecular weight (Mw) greater than 30 a.m.u., preferably greater than 35 a.m.u, and more preferably greater than 40 a.m.u. In another embodiment, the fluorocarbons of the invention have a Mw greater than 60 a.m.u, preferably greater than 65 a.m.u, even more preferably greater than 70 a.m.u, and most preferably greater than 80 a.m.u. In still another embodiment, the fluorocarbons of the invention have a Mw greater than 90 a.m.u, preferably greater than 100 a.m.u, even more preferably greater than 135 a.m.u, and most preferably greater than 150 a.m.u. In another embodiment, the fluorocarbons of the invention have a Mw greater than 140 a.m.u, preferably greater than 150 a.m.u, more preferably greater than 180 a.m.u, even more preferably greater than 200 a.m.u, and most preferably greater than 225 a.m.u. In an embodiment, the fluorocarbons of the invention have a Mw in the range of from 90 a.m.u to 1000 a.m.u, preferably in the range of from 100 a.m.u to 500 a.m.u, more preferably in the range of from 100 a.m.u to 300 a.m.u, and most preferably in the range of from about 100 a.m.u to about 250 a.m.u.

In yet another embodiment, the fluorocarbons of the invention have normal boiling point in the range of from about −100° C. up to the polymerization temperature, preferably up to about 70° C., preferably up to about 85 to 115° C., preferably the normal boiling point of the fluorocarbons is in the range of from −80° C. to about 90° C., more preferably from about −60° C. to about 85° C., and most preferably from about −50° C. to about 80° C. In an embodiment, the fluorocarbons of the invention have normal boiling point greater than −50° C., preferably greater than −50° C. to less than −10° C. In a further embodiment, the fluorocarbons of the invention have normal boiling point greater than −5° C., preferably greater than −5° C. to less than −20° C. In one embodiment, the fluorocarbons of the invention have normal boiling point greater than 10° C., preferably greater than 10° C. to about 60° C.

In another embodiment, the fluorocarbons of the invention have a liquid density @ 20° C. (g/cc) less than 2 g/cc, preferably less than 1.6, preferably less than 1.5 g/cc, preferably less than 1.45 g/cc, preferably less than 1.40, and most preferably less than 1.20 g/cc.

In one embodiment, the fluorocarbons of the invention have a ΔH Vaporization at the normal boiling point as measured by standard calorimetry techniques in the range between 100 kJ/kg to less than 500 kJ/kg, preferably in the range of from 110 kJ/kg to less than 450 kJ/kg, and most preferably in the range of from 120 kJ/kg to less than 400 kJ/kg.

In another preferred embodiment, the fluorocarbons of the invention have any combination of two or more of the aforementioned Mw, normal boiling point, ΔH Vaporization, and liquid density values and ranges. In a preferred embodiment, the fluorocarbons useful in the process of the invention have a Mw greater than 30 a.m.u, preferably greater than 40 a.m.u, and a liquid density less than 2.00 g/cc, preferably less than 1.8 g/cc. In yet another preferred embodiment, the fluorocarbons useful in the process of the invention have a liquid density less than 1.9 g/cc, preferably less than 1.8 g/cc, and a normal boiling point greater than −100° C., preferably greater than −50° C. up to the polymerization temperature of the process, (such as up to 115° C.), preferably less than 100° C., and more preferably less than 90° C., and most preferably less than 60° C., and optionally a ΔH Vaporization in the range from 120 kj/kg to 400 kj/kg.

In another embodiment the fluorocarbons are used in combination with one or more hydrocarbon solvents. Preferably, the hydrocarbon solvent is an aliphatic or aromatic hydrocarbon fluids. Examples of suitable, preferably inert, solvents include, for example, saturated hydrocarbons containing from 1 to 10, preferably 3 to 8 carbon atoms, such as propane, n-butane, isobutane, n-pentane, isopentane, neopentane, n-hexane, isohexane, cyclohexane and other saturated C₆ to C₈ hydrocarbons. Preferred hydrocarbon fluids also include desulphurized light virgin naphtha, and alkanes (preferably C1 to C8 alkanes), such as propane, isobutane, mixed butanes, hexane, pentane, isopentane, cyclohexane and octane. Likewise one may also use mixtures of C3 to C20 paraffins and isoparaffins, preferably paraffinic/isoparrifinic mixtures of C4, C5 and or C6 alkanes.

In another embodiment, the fluorocarbon fluid is selected based upon its solubility or lack thereof in a particular polymer being produced. Preferred fluorocarbons have little to no solubility in the polymer. Solubility in the polymer is measured by forming the polymer into a film of thickness between 50 and 100 microns, then soaking it in fluorocarbon (enough to cover the film) for 4 hours at the relevant desired polymerization temperature and pressure in a sealed container or vessel. The film is removed from the fluorocarbon, exposed for 90 seconds to evaporate excess fluorocarbon from the surface of the film, and weighed. The mass uptake is defined as the percentage increase in the film weight after soaking. The fluorocarbon or fluorocarbon mixture is selected so that the polymer has a mass uptake of less than 4 wt %, preferably less than 3 wt %, more preferably less than 2 wt %, even more preferably less than 1 wt %, and most preferably less than 0.5 wt %.

In a preferred embodiment, the fluorocarbon(s) or mixtures thereof, preferably, the HFC's or mixtures thereof, are selected such that the polymer melting temperature Tm is reduced (or depressed) by not more than 20° C. by the presence of the fluorocarbon, preferably by not more than 15° C., preferably not more than 10° C. The depression of the polymer melting temperature ΔTm is determined by first measuring the melting temperature of a polymer by differential scanning calorimetry (DSC), and then comparing this to a similar measurement on a sample of the same polymer that has been soaked with the fluorocarbon for four minutes. In general, the melting temperature of the soaked polymer will be lower than that of the dry polymer. The difference in these measurements is taken as the melting point depression ΔTm. Higher concentrations of dissolved materials in the polymer cause larger depressions in the polymer melting temperature (i.e. higher values of ΔTm). A suitable DSC technique for determining the melting point depression is described by, P. V. Hemmingsen, “Phase Equilibria in Polyethylene Systems”, Ph.D Thesis, Norwegian University of Science and Technology, March 2000, which is incorporated herein by reference. (A preferred set of conditions for conducting the tests are summarized on Page 112 of this reference.) The polymer melting temperature is first measured with dry polymer, and then repeated with the polymer immersed in liquid (the fluorocarbon to be evaluated). As described in the reference above, it is important to ensure that the second part of the test, conducted in the presence of the liquid, is done in a sealed container so that the liquid is not flashed during the test, which could introduce experimental error. In one embodiment, the ΔTm is less than 12° C., preferably less than 10° C., preferably less than 8° C., more preferably less than 6° C., and most preferably less than 4° C. In another embodiment, the measured ΔTm is less than 5° C., preferably less than 4° C., more preferably less than 3° C., even more preferably less than 2° C., and most preferably less than 1° C.

In a preferred embodiment, the fluorocarbon(s) or mixtures thereof, preferably, the fluorocarbon or mixtures thereof, are selected such that these are miscible to the hydrocarbon solvent and liquid monomers when a mixture is used. In a preferred embodiment, the fluorocarbon(s) or mixtures thereof, preferably, the fluorocarbon or mixtures thereof, are selected such that these are miscible to the hydrocarbon solvent and liquid monomers when a mixture is used. By miscible is meant that the FC/hydrocarbon mixture will not have liquid phase separation. Liquid phase separation is determined by mixing a fluorocarbon and a hydrocarbon in a vessel with sight glass at polymerization conditions, then visually observing if phase separation occurs after vigorous mixing for five minutes.

For the propylene/ethylene copolymer processes described herein, optionally containing additional unsaturated monomer, the weight ratio of propylene to ethylene in the feed to the reactors is preferably in the range of 10,000:1 to 1:10, more preferably 1,000:1 to 1:1, still more preferably 500:1 to 3:1. For the propylene/C4-C20 alpha-olefin copolymer processes of the present invention, the weight ratio of propylene to C4-C20 alpha-olefin in the feed preferably is in the range of 10,000:1 to 1:20, more preferably 1,000:1 to 1:1, still more preferably 1,000:1 to 3:1.

The post-reactor processing of the recover reaction mass from the polymerization vessel typically includes the deactivation of the catalyst, removal of catalyst residue, drying of the product, and the like. The recovered polymer is then ready for storage and/or use.

The propylene copolymer produced in a single reaction vessel in accordance with this invention will have the desired MFR, narrow MWD. If, however, a broader MWD is desired, e.g., a MWD of between about 2.5 and about 3.5 or even higher, without any substantial change to the other defining characteristics of the propylene copolymer, then the copolymer is preferably made in a multiple reactor system. In multiple reactor systems, MWD as broad as 15, more preferably 10, most preferably 4-8, can be prepared.

Preferably, to obtain a broad MWD, at least two of the catalysts used in a single reactor where at least one catalyst produces polymer with high molecular weight and at least one other catalyst produces polymer with low molecular weight. The ratio of a high weight-average molecular weight (MwH) to the low weight average molecular weight (MwL) (MwH/MwL) is in the range from about 1.5 to about 10, and the process used is a gas phase, slurry, or solution process. More preferably, at least two of the catalysts used in a single reactor have MwH/MwL in the range from about 1.5 to about 10, and the process used is a continuous solution process, especially a continuous solution process wherein the polymer concentration in the reactor at steady state is at least 15% by weight of the reactor contents. Still more preferably, at least two of the catalysts used in a single reactor have MwH/MwL in the range from about 1.5 to about 10, and the process used is a continuous solution process wherein the polymer concentration in the reactor at steady state is at least 18% by weight of the reactor contents. Most preferably, at least two of the catalysts used in a single reactor have MwH/MwL in the range from about 1.5 to about 10, and the process used is a continuous solution process wherein the polymer concentration in the reactor at steady state is at least 20% by weight of the reactor contents. Preferably, fluorocarbon, a mixture of fluorocarbon or a mixture of fluorocarbon and hydrocarbon is introduced in to the reactor as a solvent or diluent. Likewise, the fluorocarbons may be introduced into the reactor as a mixture with one or more catalyst system components or a scavenger.

In one embodiment, the monomers comprise propylene and at least one olefin selected from the group consisting of C4-C10 alpha-olefins, especially 1-butene, 1-hexene, and 1-octene, and the melt flow rate (MFR) of the interpolymer is preferably in the range of about 0.1 to about 500, more preferably in the range from about 0.1 to about 100, further more preferably about 0.2 to 80, most preferably in the range of 0.3-50. In some embodiments, the nonmetallocene, catalysts used in the practice of the invention described herein may be utilized in combination with at least one additional homogeneous or heterogeneous polymerization catalyst in separate reactors connected in series or in parallel to prepare polymer blends having desirable properties. an example of such a process is disclosed in WO 94/00500, equivalent to U.S. Ser. No. 07/904,770, as well as U.S. Ser. No. 08/10958, filed Jan. 29, 1993. Included in these embodiments is the use of two different nonmetallocene, metal-centered, heteroaryl ligand catalysts. Preferably, the fluorocarbon or a mixture of fluorocarbons is added in the first reactor, or the second reactor when reactors are connected in series. Advantageously, fluorocarbon may be added in the second reactor to lower the viscosity of the reaction medium or induce polymer phase separation. For parallel reactor operation, the fluorocarbon or a mixture of fluorocarbons is introduced into either of the reactor or both.

The catalyst system may be prepared as a homogeneous catalyst by addition of the requisite components to a solvent in which polymerization will be carried out by solution polymerization procedures. The catalyst system may also be prepared and employed as a heterogeneous catalyst by adsorbing the requisite components on a catalyst support material such as silica gel, alumina or other suitable inorganic support material. When prepared in heterogeneous or supported form, it is preferred to use silica as the support material. The heterogeneous form of the catalyst system may be employed in a slurry or gas phase polymerization. As a practical limitation, slurry polymerization takes place in liquid diluents in which the polymer product is substantially insoluble. Preferably, the diluent for slurry polymerization is one or more hydrocarbons with less than 5 carbon atoms. If desired, saturated hydrocarbons such as ethane, propane or butane may be used in whole or part as the diluent. Preferably, the diluent for slurry polymerization is one or more fluorocarbon, or a mixture of fluorocarbon and hydrocarbon solvents. Presence of fluorocarbon in the reaction medium reduces the polymer swell and enables the slurry process to produce lower crystallinity or low melting temperature polymers. Likewise the alpha-olefin comonomer or a mixture of different alpha-olefin comonomers may be used in whole or part as the diluent. Most preferably, the major part of the diluent comprises at least the alpha-olefin monomer or monomers to be polymerized. Preferably, one or more fluorocarbon, or a mixture of fluorocarbon is mixed with the monomers to form a diluent. Preferably, the selected fluorocarbon is miscible with the monomers.

Solution polymerization conditions utilize a solvent for the respective components of the reaction. Preferred solvents include, but are not limited to, mineral oils and the various hydrocarbons which are liquid at reaction temperatures and pressures. Illustrative examples of useful solvents include, but are not limited to, alkanes such as pentane, iso-pentane, hexane, heptane, octane and nonane, as well as mixtures of alkanes including kerosene and Isopar E™, available from ExxonMobil Chemical Inc; cycloalkanes such as cyclopentane, cyclohexane, and methylcyclohexane; and aromatics such as benzene, toluene, xylenes, ethylbenzene and diethylbenzene. In another embodiment, controlled amounts of fluorocarbon are introduced into the solution reactor such that the viscosity of the reaction medium is greatly reduced or the concentration of polymer solute is greatly increased without significant change of reaction medium viscosity. In another embodiment, controlled volume of fluorocarbon is introduced into the solution reactor such that polymer phase separation occurs to form a polymer rich phase and a polymer lean phase.

At all times, the individual ingredients, as well as the catalyst components, should be protected from oxygen and moisture. Therefore, the catalyst components and catalysts should be prepared and recovered in an oxygen and moisture free atmosphere. Preferably, therefore, the reactions are performed in the presence of a dry, inert gas such as, for example, nitrogen or argon.

The polymerization may be carried out as a batch or a continuous polymerization process. A continuous process is preferred, in which event catalysts, solvent or diluent (if employed), and comonomers (or monomer) are continuously supplied to the reaction zone and polymer product continuously removed therefrom. The polymerization conditions for manufacturing the interpolymers according to embodiments of the invention are generally those useful in the solution polymerization process and a modified solution process, although the application is not limited thereto. Gas phase and slurry polymerization processes are also believed to be useful. For purposes of this invention and the claims thereto when a process is referred to as a modified solution process it includes processes typically regarded as solution except that fluorocarbons are used as part or all of the reaction medium. Because a solution process is one where the polymer is soluble in the reaction media and the fluorocarbons tend to act to reduce solubility of the polymer in the reaction medium, we refer to such reactions a modified solution processes. A modified solution process may be, but is not necessarily, a slurry process.

In some embodiments, the polymerization is conducted in a continuous solution, modified solution or slurry polymerization system comprising two or more reactors connected in series or parallel. A catalyst solution comprising a nonmetallocene, metal-centered, heteroaryl ligand catalyst as described previously is used to polymerize propylene and optionally additional olefin monomers in at least one reactor. In one reactor, a relatively high molecular weight product (Mw from 100,000 to over 1,000,000, more preferably 200,000 to 500,000) is formed while in the second or subsequent reactor(s) a product of a relatively low molecular weight (Mw 2,000 to 300,000) is formed. The final product is a mixture of the two reactor effluents which are combined prior to devolatilization to result in a uniform mixing of the two polymer products. Such a dual reactor/dual catalyst process allows for the preparation of products with tailored properties. Preferably, controlled amounts of fluorocarbon(s) are introduced into either the first reactor or the second reactor or both. Advantageously, the fluorocarbon is added into the first reactor when low crystallinity polymer is produce, and fluorocarbon is added into the second reactor when high molecular weight polymer is produced or high polymer solute concentration is employed.

In one embodiment, the reactors are connected in series, that is the effluent from the first reactor is charged to the second reactor and fresh monomer(s), solvent and hydrogen is added to the second reactor. Reactor conditions are adjusted such that the weight ratio of polymer produced in the first reactor to that produced in the second reactor typically from about 20:80 to about 80:20. Preferably, the weight ratio of polymer produced in the first reactor to that produced in the second reactor is from about 25:75 to about 75:25, more preferably from about 30:70 to about 70:30. Preferably controlled volumes of fluorocarbon(s) are introduced into either the first reactor or the second reactor or both. Advantageously, the fluorocarbon is added into the first reactor when low crystallinity polymer is produced, and fluorocarbon is added into the second reactor when high molecular weight polymer is produced or high polymer solute concentration is employed.

One representative example of a series polymerization is the preparation of propylene copolymer in which in the first reactor, propylene, ethylene, solvent and catalyst are contacted under solution phase conditions such that the propylene and ethylene copolymerize to form propylene copolymer. One of ordinary skill in the art understands that many variations on this theme are possible by replacing ethylene with, or using in combination with ethylene, one or more unsaturated comonomers; using a second but related catalyst in the second reactor; etc. In multiple reactor processes the fluorocarbon may be introduced into one or all of the reactors. In particular, a fluorocarbon can be introduced into the first reactor, and a second fluorocarbon (which may be the same or different from the first fluorocarbon) may be introduced into the second reactor. Likewise the fluorocarbon may be introduced in the first reactor alone or the second reactor alone.

In one embodiment, the second reactor in a series polymerization process contains a heterogeneous Ziegler-Natta catalyst or chrome catalyst known in the art. Examples of Ziegler-Natta catalysts include, but are not limited to, titanium-based catalysts supported on MgCl₂, and additionally comprise compounds of aluminum containing at least one aluminum-alkyl bond. Suitable Ziegler Natta catalysts and their preparation include, but are not limited to, those disclosed in U.S. Pat. Nos. 4,612,300, 4,330,646 and 5,869,575. In another embodiment of the present invention, the second reactor in a series polymerization process contains a constrained geometry or a bis-Cp metallocene catalyst. Fluorocarbon may be introduced into either the first reactor, the second reactor or both.

In another embodiment of this invention, propylene/ethylene copolymers are prepared in high yield and productivity in the presence of a fluorocarbon. The process employed to make these copolymers may be either a solution or slurry process both of which are known in the art. Kaminsky, J. Poly. Sci., Vol. 23, pp. 2151-64 (1985) reported the use of a soluble bis(cyclopentadienyl)zirconium dimethyl-alumoxane catalyst system for solution polymerization of propylene/ethylene (PE) elastomers. U.S. Pat. No. 5,229,478 discloses a slurry polymerization process utilizing similar bis(cyclopentadienyl)zirconium based catalyst systems.

The following procedure may be carried out to obtain a P/E* copolymer: In a stirred-tank reactor propylene monomer is introduced continuously together with solvent, and ethylene monomer. The reactor contains a liquid phase composed substantially of ethylene and propylene monomers together with any solvent or additional diluent. If desired, a small amount of a “H”-branch inducing diene such as norbornadiene, 1,7-octadiene or 1,9-decadiene may also be added. A nonmetallocene, metal-centered, heteroaryl ligand catalyst and suitable cocatalyst are continuously introduced in the reactor liquid phase. The reactor temperature and pressure may be controlled by adjusting the solvent/monomer ratio, the catalyst addition rate, as well as by cooling or heating coils, jackets or both. The polymerization rate is controlled by the rate of catalyst addition. The ethylene content of the polymer product is determined by the ratio of ethylene to propylene in the reactor, which is controlled by manipulating the respective feed rates of these components to the reactor. The polymer product molecular weight is controlled, optionally, by controlling other polymerization variables such as the temperature, monomer concentration, or by a stream of hydrogen introduced to the reactor, as is known in the art. The reactor effluent is contacted with a catalyst kill agent, such as water. The polymer solution is optionally heated, and the polymer product is recovered by flashing off unreacted gaseous ethylene and propylene as well as residual solvent or diluent at reduced pressure, and, if necessary, conducting further devolatilization in equipment such as a devolatilizing extruder or other devolatilizing equipment operated at reduced pressure. (In any of the embodiments described herein the materials devolatilized using the devolatilizing extruder may be passed through activated carbon to remove all or part of the FC's.) Preferably, the solvent comprises fluorocarbon, or a mixture of fluorocarbons or fluorocarbon and hydrocarbon. For solution process operation, the amount of fluorocarbon is controlled such that little or no polymer precipitation occurs in the reaction medium. On the other hand, the amount of fluorocarbon needs to be sufficient to induce phase separation of polymer produced in a slurry process or modified solution process. For a solution polymerization process, especially a continuous solution polymerization, preferred ranges of propylene concentration at steady state are from about 0.05 weight percent of the total reactor contents to about 80 weight percent of the total reactor contents, more preferably from about 0.5 weight percent of the total reactor contents to about 30 weight percent of the total reactor contents, and most preferably from about 1 weight percent of the total reactor contents to about 25 weight percent of the total reactor contents. The preferred range of polymer concentration (otherwise known as % solids) is from about 3% of the reactor contents by weight to about 45% of the reactor contents or higher, more preferably from about 10% of the reactor contents to about 40% of the reactor contents, and most preferably from about 15% of the reactor contents to about 40% of the reactor contents.

In a continuous process, the mean residence time of the catalyst and polymer in the reactor generally is from 5 minutes to 8 hours, and preferably from 10 minutes to 6 hours, more preferably from 10 minutes to 1 hour.

In some embodiments, ethylene is added to the reaction vessel in an amount to maintain a differential pressure in excess of the combined vapor pressure of the propylene and diene monomers. The ethylene content of the polymer is determined by the ratio of ethylene differential pressure to the total reactor pressure. Generally the polymerization process is carried out with a pressure of ethylene of from 10 to 1000 psi (70 to 7000 kPa), most preferably from 40 to 800 psi (30 to 600 kPa). The polymerization is generally conducted at a temperature of from 25 to 250° C., preferably from 75 to 200° C., and most preferably from greater than 95 to 200° C.

In another embodiment of the invention, a process for producing a propylene homopolymer or interpolymer of propylene with at least one additional olefinic monomer selected from ethylene or C4-C20 alpha-olefins comprises the following steps: 1) providing controlled addition of a nonmetallocene, metal-centered, heteroaryl ligand catalyst to a reactor, including a cocatalyst and optionally a scavenger component; 2) continuously feeding propylene and optionally one or more additional olefinic monomers independently selected from ethylene or C4-C20 alpha-olefins into the reactor; 3) continuously feeding one or more fluorocarbons optionally with a solvent or diluent, and optionally with a controlled amount of hydrogen; and 4) recovering the polymer product. Preferably, the process is a continuous solution process. Preferably a controlled volume of FC component(s) is mixed with the hydrocarbon solvent and monomers in the feed preparation section before injection into the reactors. The boiling point of the FC is preferably higher than ethylene and propylene so that the FC will co-condense and recycle with the hydrocarbon solvent, if any (typically hexanes), preferably the boiling point is in the range of from 0 to 70° C. The cocatalysts and optional scavenger components in the novel process can be independently mixed with the catalyst component before introduction into the reactor, or they may each independently be fed into the reactor using separate streams, resulting in “in reactor” activation. Scavenger components are known in the art and include, but are not limited to, alkyl aluminum compounds, including alumoxanes. Examples of scavengers include, but are not limited to, trimethyl aluminum, triethyl aluminum, triisobutyl aluminum, trioctyl aluminum, methylalumoxane (MAO), and other alumoxanes including, but not limited to, MMAO-3A, MMAO-7, PMAO-IP (all available from Akzo Nobel). Likewise, the fluorocarbons may be introduced into the reactor as a mixture with one or more catalyst system components or a scavenger.

As previously noted, the process described above may optionally use more than one reactor. The use of a second reactor is especially useful in those embodiments in which an additional catalyst, especially a Ziegler-Natta or chrome catalyst, or a metallocene catalyst, especially a CGC, is employed. The second reactor typically holds the additional catalyst.

By proper selection of process conditions, including catalyst selection, polymers with tailored properties can be produced. For a solution polymerization process, especially a continuous solution polymerization, preferred ranges of ethylene concentration at steady state are from less than about 0.02 weight percent of the total reactor contents to about 20 weight percent of the total reactor contents, and the preferred range of polymer concentration is from about 10% of the reactor contents by weight to about 45% of the reactor contents or higher. Advantageously, fluorocarbon is added into the reactor to reduce viscosity. Fluorocarbon may also be introduced into the reactor effluent. The amount of fluorocarbon added to the effluent should be sufficient to induce polymer phase separation.

In any of the embodiments described herein the materials stripped or flashed off may be passed through activated carbon to remove all or part of the FC's.

In general, catalyst efficiency (expressed in terms of gram of polymer produced per gram of transition metal) decreases with increasing temperature and decreasing ethylene concentration. In addition, the molecular weight of the polymer product generally decreases with increasing reactor temperature and decreases with decreasing propylene and ethylene concentration. The molecular weight of the polyolefin can also be controlled with the addition of chain transfer compounds, especially through the addition of hydrogen.

When two or more different catalysts are used in certain embodiments disclosed herein, each catalyst may make a different molecular weight product. A high molecular weight catalyst is defined relative to a low molecular weight catalyst. A high weight molecular weight catalyst refers to a catalyst which by itself produces a polymer with a high weight-average molecular weight MwH from the comonomers of choice under a set of given polymerization conditions, whereas a low molecular weight catalyst refers to a catalyst which by itself produces a polymer with a low weight average molecular weight MwL from the same comonomers under substantially the same polymerization conditions. Moreover, the ratio of the high molecular weight to the low molecular weight, i.e., MwH/MwL is greater than about 1.3. Generally, the ratio, MwH/MwL, is in the range from about 1.5 to about 60, preferably in the range from about 1.5 to about 40, and more preferably from about 1.5 to about 10. In some embodiments, the ratio is from about 3.0 to about 6.0. In other embodiments, the ratio MwH/MwL can be greater than 60 (e.g., 70, 80, 90, or even 100), but it is generally less preferred.

A high molecular weight catalyst and a low molecular weight catalyst are determined with reference to each other. One does not know whether a catalyst is a high molecular weight catalyst or a low molecular weight catalyst until after another catalyst is also selected.

Therefore, the terms “high molecular weight” and “low molecular weight” used herein when referring to a catalyst are merely relative terms and do not encompass any absolute value with respect to the molecular weight of a polymer. After a pair of catalysts are selected, one can easily ascertain which one is the high molecular catalyst by the following procedure: 1) select at least one monomer which can be polymerized by the chosen catalysts; 2) make a polymer from the selected monomer(s) in a single reactor containing one of the selected catalysts under pre-selected polymerization conditions; 3) make another polymer from the same monomer(s) in a single reactor containing the other catalyst under substantially the same polymerization conditions; and 4) measure the MFR for the respective interpolymers. The catalyst that yields a lower MFR is the higher molecular weight catalyst. Conversely, the catalyst that yields a high MFR is the lower molecular weight catalyst. Using this methodology, it is possible to rank a plurality of catalysts based on the molecular weight of the polymers they can produce under substantially the same conditions. As such, one may select three, four, five, six, or more catalysts according their molecular weight capability and use these catalysts simultaneously in a single polymerization reactor to produce polymers with tailored structures and properties.

The nature of the polymer product of the instant invention depends on the characteristics of each catalyst as well as the specifics of the process in which the catalysts are used. By careful choice of each catalyst, the polymer product can be tailored to achieve specific properties. For example, in order to obtain a polymer with a broader molecular weight distribution, two (or more) catalysts preferably should be chosen so that the difference in molecular weight at the conditions of polymerization (MwH/MwL) is large, preferably greater than 4.0, more preferably greater than 6.0, even more preferably greater than 8.0. For a narrower MWD product, the catalysts preferably should be chosen so that MwH/MwL is relatively low, preferably 4.0 or less, more preferably 3.0 or less, still more preferably 2.5 or less.

In one embodiment of the invention, a process for producing a propylene homopolymer or interpolymer of propylene with at least one additional olefinic monomer selected from ethylene or C4-C20 alpha-olefins comprises the following steps: 1) providing controlled addition of a nonmetallocene, metal-centered, pyridyl-amine catalyst to a reactor, including a cocatalyst and optionally a scavenger component; 2) continuously feeding propylene and optionally one or more additional olefinic monomers independently selected from ethylene or C4-C20 alpha-olefins into the reactor; 3) feeding fluorocarbon into the polymerization reactor, optionally with a solvent or diluent, and optionally with a controlled amount of hydrogen, 4) feeding a second catalyst to the same reactor, including a cocatalyst and optionally a scavenger; and 5) recovering the polymer product. Preferably, the process is a continuous solution process or continuous modified solution process. The cocatalysts and optional scavenger components in the novel process can be independently mixed with each catalyst component before introduction into the reactor, or they may each independently be fed into the reactor using separate streams, resulting in “in reactor” activation. The novel process described above may optionally use more than one reactor, especially where a second reactor is used wherein the second reactor comprises an additional catalyst, especially a Ziegler-Natta or chrome catalyst, a metallocene catalyst or a CGC.

Applications

The polymers made in accordance with embodiments of the invention have many useful applications. For example, fabricated articles made from the polymers may be prepared using all of the conventional polyolefin processing techniques. Useful articles include films (e.g., cast, blown, calendaring and extrusion coated), including multi-layer films, greenhouse films, shrink films including clarity shrink film, lamination film, biaxially-oriented film, extrusion coating, liners, clarity liners, overwrap film, agricultural film; fibers (e.g., staple fibers) including use of an interpolymer disclosed herein as at least one component comprising at least a portion of the fiber's surface), spunbond fibers or melt blown fibers (using, e.g., systems as disclosed in U.S. Pat. No. 4,430,563, 4,663,220, 4,668,566 or 4,322,027), and gel spun fibers (e.g., the system disclosed in U.S. Pat. No. 4,413,110); both woven and nonwoven fabrics (e.g., spunlaced fabrics disclosed in U.S. Pat. No. 3,485,706) or structures made from such fibers (including, e.g., blends of these fibers with other fibers such as PET or cotton), foams, and thermoform and molded articles (e.g., made using an injection molding process, a blow molding process or a rotomolding process). Monolayer and multilayer films may be made according to the film structures and fabrication methods described in U.S. Pat. No. 5,685,128.

The inventive polymers exhibit excellent optics. The polymers of this invention also exhibit excellent elasticity.

The elastomeric polymers of this invention can be used in a variety of different applications including fiber, film, sheeting and molded articles. Whether or not pre-stretching is desirable will depend upon the application. For example, the elastomeric polymers of this invention can replace the thermoplastic triblock elastomers as the filament layer in the stretch bonded laminate process of U.S. Pat. No. 6,323,389. The filament layer would be stretched, preferably only once, prior to being sandwiched between the two spunbond layers. In an alternative example, the elastomeric polymers of this invention can replace the elastic layer in the necked bonded laminate process of U.S. Pat. No. 5,910,224. Some pre-stretching of the propylene polymer may be preferred.

With respect to injection molding applications, the polymers of this invention exhibit a good balance between low haze values and toughness.

With respect to blown film applications, the inventive polymers exhibit excellent optics, e.g., low haze and high gloss, and much better toughness (e.g., tear and dart) than traditional Ziegler-Natta catalyzed polypropylene at comparable ethylene contents. The inventive polymers also exhibit superior toughness and haze and gloss at equivalent modulus than many traditional polyethylenes, e.g., linear low density polyethylene, and certain polyethylene blends, e.g., in-reactor blends of at least one metallocene catalyzed polyethylene and at least one Ziegler-Natta catalyzed polyethylene.

The polymers of this invention are also useful for wire and cable coating operations, wire and cable jacketing, including low, medium and high voltage cable jacketing, semi-conductive layers used in wire and cable power applications, wire and cable insulation, especially medium and high voltage cable insulation, telecommunications cable jackets, optical fiber jackets, as well as in sheet extrusion for vacuum forming operations. In addition, the novel polymers may be used in foams, including high strength foam, soft foam, rigid foam, cross-linked foam, high strength foam for cushioning applications, and sound insulation foam, blow molded bottles, frozen food packages; thermoforming, especially cups and plates, trays and containers; injection moulding; blow-moulding; pipe, including potable water pipe and high pressure pipe; and automotive parts. The one or ordinary skill in the art will appreciate other uses for the novel polymers and compositions disclosed herein.

Useful compositions are also suitably prepared comprising the polymers according to embodiments of the invention and at least one other natural or synthetic polymer. Preferred other polymers include, but are not limited to, thermoplastics, such as styrene-butadiene block copolymers, polystyrene (including high impact polystyrene), ethylene vinyl alcohol copolymers, ethylene acrylic acid copolymers, other olefin copolymers (especially polyethylene copolymers) and homopolymers (e.g., those made using conventional heterogeneous catalysts). Examples include polymers made by the process of U.S. Pat. No. 4,076,698, other linear or substantially linear polymers as described in U.S. Pat. No. 5,272,236, and mixtures thereof. Other substantially linear polymers and conventional HDPE and/or LDPE may also be used in the thermoplastic compositions.

For one aspect of the present invention, the novel polymers are useful to produce foams having improved properties. For foams, and other applications requiring melt strength, the MFR is preferably in the range of 0.1-10, more preferably 0.3-3, most preferably 0.5-2. The melt strength is preferably greater than 5 cN, more preferably >9 cN, most preferably >12 Cn. The drawability is preferably >15 mm/sec, more preferably >25 mm/sec, most preferably >35 mm/sec.

In one aspect of the present invention, the novel polymers disclosed in the present invention are useful for a wide range of applications where good optical properties are beneficial. Gloss is measured according to ASTM D-1746. Haze is measured according to ASTM D-1003, and Clarity is measured according to ASTM D-2457. In one aspect of the polymers disclosed herein, films having haze of less than 10% can be produced. In addition films having clarity of >91% are beneficially obtained.

The polymers of this invention, either alone or in combination with one or more other polymers (either polymers of the invention or polymers not of the invention) may be blended, if desired or necessary, with various additives such as antioxidants, ultraviolet absorbing agents, antistatic agents, nucleating agents, lubricants, flame retardants, antiblocking agents, colorants, inorganic or organic fillers or the like.

As noted above, the polymers of this invention are useful in the preparation of fibers and films. With respect to fibers, elastic fibers comprising polyolefins are known, e.g., U.S. Pat. Nos. 5,272,236, 5,278,272, 5,322,728, 5,380,810, 5,472,775, 5,645,542, 6,140,442 and 6,225,243. The polymers of this invention can be used in essentially the same manner as known polyolefins for the making and using of elastic fibers. In this regard, the polymers of this invention can include functional groups, such as a carbonyl, sulfide, silane radicals, etc., and can be crosslinked or uncrosslinked. If crosslinked, the polymers can be crosslinked in any known manner, e.g., peroxide, azo, electromagnetic radiation such as electron beam, UV, IR, visible light, and the like. The use of additives, promoters, etc., can be employed as desired.

The polypropylene polymers of this invention can be blended with other polymers to form, among other things, useful fibers. Suitable polymers for blending with the polypropylene polymers of this invention are commercially available from a variety of suppliers and include, but are not limited to, other polyolefins such as an ethylene polymer (e.g., low density polyethylene (LDPE), ULDPE, medium density polyethylene (MDPE), LLDPE, HDPE, homogeneously branched linear ethylene polymer, substantially linear ethylene polymer, graft-modified ethylene polymer ethylene-styrene interpolymers, ethylene vinyl acetate interpolymer, ethylene acrylic acid interpolymer, ethylene ethyl acetate interpolymer, ethylene methacrylic acid interpolymer, ethylene methacrylic acid ionomer, and the like), polycarbonate, polystyrene, conventional polypropylene (e.g., homopolymer polypropylene, polypropylene copolymer, random block polypropylene interpolymer and the like), thermoplastic polyurethane, polyamide, polylactic acid interpolymer, thermoplastic block polymer (e.g. styrene butadiene copolymer, styrene butadiene styrene triblock copolymer, styrene ethylene-butylene styrene triblock copolymer and the like), polyether block copolymer (e.g., PEBAX), copolyester polymer, polyester/polyether block polymers (e.g., HYTEL), ethylene carbon monoxide interpolymer (e.g., ethylene/carbon monoxide (ECO), copolymer, ethylene/acrylic acid/carbon monoxide (EAACO) terpolymer, ethylene/methacrylic acid/carbon monoxide (EMAACO) terpolymer, ethylene/vinyl acetate/carbon monoxide (EVACO) terpolymer and styrene/carbon monoxide (SCO)), polyethylene terephthalate (PET), chlorinated polyethylene, and the like and mixtures thereof. In other words, the polyolefin used in the practice of this invention can be a blend of two or more polyolefins, or a blend of one or more polyolefins with one or more polymers other than a polyolefin. If the polyolefin used in the practice of this invention is a blend of one or more polyolefins with one or more polymers other than a polyolefin, then the polyolefins comprise at least about 1, preferably at least about 50 and more preferably at least about 90, wt % of the total weight of the blend.

In one embodiment, one or more polypropylene polymers of this invention is blended with a conventional polypropylene polymer. Suitable conventional polypropylene polymers for use in the invention, including random propylene ethylene polymers, are available from a number of manufacturers, such as, for example, Montell Polyolefins and ExxonMobil Chemical Company. Suitable conventional polypropylene polymers from ExxonMobil are supplied under the designations ESCORENE™ and ACHIEVE™.

Suitable graft-modified polymers for use in this invention are well known in the art, and include the various ethylene polymers bearing a maleic anhydride and/or another carbonyl-containing, ethylenically unsaturated organic radical. Representative graft-modified polymers are described in U.S. Pat. No. 5,883,188, such as a homogeneously branched ethylene polymer graft-modified with maleic anhydride.

Suitable polylactic acid (PLA) polymers for use in the invention are well known in the literature (e.g., see D. M. Bigg et al., “Effect of Copolymer Ratio on the Crystallinity and Properties of Polylactic Acid Copolymers”, ANTEC '96, pp. 2028-2039; WO 90/01521; EP 0 515 203A and EP 0 748 846 A2. Suitable polylactic acid polymers are supplied commercially by Cargill Dow under the designation EcoPLA.

Suitable thermoplastic polyurethane polymers for use in the invention are commercially available from The Dow Chemical Company under the designation PELLATHANE.

Suitable polyolefin carbon monoxide interpolymers can be manufactured using well known high pressure free-radical polymerization methods. However, they may also be manufactured with the use of so-called homogeneous catalyst systems such as those described and referenced above.

Suitable free-radical initiated high pressure carbonyl-containing ethylene polymers such as ethylene acrylic acid interpolymers can be manufactured by any technique known in the art including the methods taught by Thomson and Waples in U.S. Pat. Nos. 3,520,861, 4,988,781; 4,599,392 and 5,384,373.

Suitable ethylene vinyl acetate interpolymers for use in the invention are commercially available from various suppliers, including ExxonMobil Chemical Company and Du Pont Chemical Company.

Suitable ethylene/alkyl acrylate interpolymers are commercially available from various suppliers. Suitable ethylene/acrylic acid interpolymers are commercially available from The Dow Chemical Company under the designation PRIMACOR. Suitable ethylene/methacrylic acid interpolymers are commercially available from Du Pont Chemical Company under the designation NUCREL. Suitable ethylene/acrylic acid interpolymers are commercially available from ExxonMobil Chemical Company under the designation ESCOR.

Chlorinated polyethylene (CPE), especially chlorinated substantially linear ethylene polymers, can be prepared by chlorinating polyethylene in accordance with well known techniques. Preferably, chlorinated polyethylene comprises equal to or greater than 30 weight percent chlorine. Suitable chlorinated polyethylenes for use in the invention are commercially supplied by The Dow Chemical Company under the designation TYRIN.

The polypropylene polymer, if elastic, can also be shaped or fabricated into elastic films, coatings, sheets, strips, tapes, ribbons and the like. The elastic film, coating and sheet of the present invention may be fabricated by any method known in the art, including blown bubble processes (e.g., simple bubble as well as biaxial orientation techniques such trapped bubble, double bubble and tenter framing), cast extrusion, injection molding processes, thermoforming processes, extrusion coating processes, profile extrusion, and sheet extrusion processes. Simple blown bubble film processes are described, for example, in The Encyclopedia of Chemical Technology, Kirk-Othmer, Third Edition, John Wiley & Sons, New York, 1981, Vol. 16, pp. 416-417 and Vol. 18, pp. 191-192. The cast extrusion method is described, for example, in Modem Plastics Mid-October 1989 Encyclopedia Issue, Volume 66, Number 11, pages 256 to 257. Injection molding, thermoforming, extrusion coating, profile extrusion, and sheet extrusion processes are described, for example, in Plastics Materials and Processes, Seymour S. Schwartz and Sidney H. Goodman, Van Nostrand Reinhold Company, New York, 1982, pp. 527-563, pp. 632-647, and pp. 596-602.

Not only can the polymers of this invention be blended with one or more other polymers, but they can also be blended with various additives such as nucleating, clarifying, stiffness and/or crystallization rate agents. These agents are used in a conventional matter and in conventional amounts.

The polymers of this invention can also be functionalized by adding one or more functional groups, e.g. through the use of a functionalized azide, to the polymer chain in a post-reaction operation. Optionally, the polymers of this invention can be subjected to post-reaction treatments, e.g. crosslinking, vis-breaking, and the like. Vis-breaking is particularly useful in reducing the viscosity of high molecular weight polymers. These post treatments are also used in their conventional manner.

### EXAMPLES

The polymerization was performed in a 0.5-liter autoclave reactor equipped with a stirrer, an external water/steam jacket for temperature control, a regulated supply of dry nitrogen, ethylene, propylene, and a septum inlet for introduction of other solvents/fluorocarbons, catalysts and scavenger solutions. The polymerization was conducted in a semi-batch mode with continuous ethylene feed. The reactor was dried and degassed thoroughly prior to use. All the solvent and monomers were purified by passing through a 1-liter basic alumina column activated at 600° C., followed by a column of molecular sieves activated at 600° C. or Selexsorb CD column prior to transferring into the reactor. For the runs with metallocene catalysts, 0.5 ml of triisobutyl aluminum (25 wt. % in toluene) was first injected into the reactor, then propylene and solvent including fluorocarbon were added into the reactor. The mixture was stirred and heated to a desired reaction temperature, followed by the addition of ethylene. The ethylene was fed on demand to maintain a differential pressure in excess of the combined vapor pressure of the propylene and solvents. The ethylene consumption was monitored during the reaction using a mass flow meter. The amount of ethylene addition was controlled by setting the excess differential pressure. The polymerization was terminated based on the total ethylene consumption. Thereafter, the reactor was cooled down and unreacted propylene and solvent were vented to the atmosphere. The resulting mixture, containing mostly solvent, polymer and unreacted monomers, was collected in a collection box and first air-dried in a hood to evaporate most of the solvent, and then dried in a vacuum oven at a temperature of about 90° C. for about 12 hours.

Stock solutions of catalyst and activator were first prepared. Then all the appropriate components were transferred into a catalyst charge tube using syringes. All of these were carried out in a drybox. The activated catalyst solution in the charge tube was flushed into the reactor using about 5 ml of toluene.

Examples EP1 to EP3 were produced using catalyst represented by the formula (“Cat-1”):

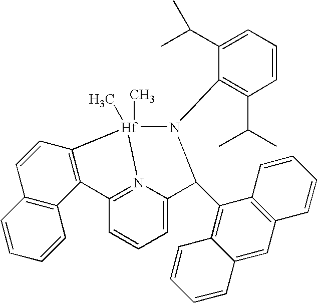

Cat-1 was preactivated with N,N-dimethylanilinium tetrakis(pentafluorophenyl)borate (“Act-1” obtained from Albemarle) at a molar ratio of 1:1 to 1:1.1. Cat-1 was a nonmetallocene, metal-centered, heteroaryl ligand catalyst that can be prepared according to the procedure at page 93 of WO 03/040201 (“H” catalyst). The detailed polymerization conditions are listed in Table E1.

TABLE E1
Polymerization conditions and polymer properties

| | Run # | | |
|---|---|---|---|
| | EP1 | | |
| | comparative | EP2 | EP3 |
| Reaction temperature (° C.) | 70 | 70 | 70 |
| Catalyst/activator | Cat-1/Act-1 | Cat-1/Act-1 | Cat-1/Act-1 |
| Catalyst compound (mg) | 4 | 4 | 4 |
| Solvent | Hexane | HFC245fa | HFC245fa |
| Solvent (ml) | 125 | 125 | 125 |
| Propylene (ml) | 125 | 125 | 125 |
| Ethylene (psi) | 50 | 10 | 50 |
| Reaction time (min) | 13 | 30 | 19 |
| Yield (g) | 47.9 | 10.5 | 12.3 |
| Tc (° C.) | 78.6 | | 83.2 |
| Tm (° C.) | 103.3 | | 136.5 |
| Tg (° C.) | −46.6 | −57.8 | −57.8 |
| Heat of fusion (J/g) | 40.4 | 0 | 1.1 |
| Ethylene content (%) | 16.8 | 49.1 | 47.1 |

HFC245fa is 1,1,1,3,3-Pentafluoropropane obtained from Honeywell under the tradename Enovate 3000.

Polymerization for Examples EP4 to EP6 was carried in a liquid filled, single-stage continuous reactor. The reactor was a 0.5-liter stainless steel autoclave reactor and was equipped with a stirrer, a water-cooling/steam-heating element with a temperature controller, and a pressure controller. Solvents, monomers such as ethylene and propylene, and comonomers (such as butene and hexene), if present, were first purified by passing through a three-column purification system. The purification system consists of an Oxiclear column (Model # RGP-R1-500 from Labclear) followed by a 5A and a 3A molecular sieve columns. Purification columns were regenerated periodically whenever there is evidence of lower activity of polymerization. Both the 3A and 5A molecular sieve columns were regenerated in-house under nitrogen at a set temperature of 260° C. and 315° C., respectively. The molecular sieve material was purchased from Aldrich. The Oxiclear column was used as received.

The solvent/fluorocarbon, monomers and comonomers were fed into a manifold first. Ethylene from in-house supply was delivered as a gas solubilized in the chilled solvent/monomer mixture in the manifold. The mixture of solvent/fluorocarbon and monomers were then chilled to about −15° C. by passing through a chiller before fed into the reactor through a single tube. All liquid flow rates were measured using Brooks meters or Micro-Motion Coriolis-type flow meters. Ethylene flow rate was metered through a Brooks controller.

The catalyst compound used is represented by the formula (“Cat-2”): 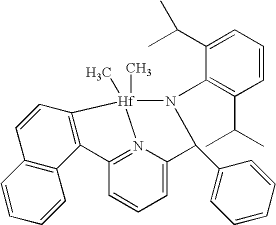
Cat-2 was preactivated with N,N-dimethylanilinium tetrakis(pentafluorophenyl)borate (“Act-1”) at a molar ratio of 1:1 to 1:1.1 in 700 ml of toluene at least 10 minutes prior to the polymerization reaction. Cat-2 was a nonmetallocene, metal-centered, heteroaryl ligand catalyst that can be prepared according to the procedure at page 90 of WO 03/040201 (“G” catalyst). All catalyst solutions were kept in an inert atmosphere with <1.5 ppm water content and fed into the reactor by metering pumps.

The contact of catalyst, solvent/fluorocarbon and monomers took place in the reactor. Catalyst pumps were calibrated periodically using toluene as the calibrating medium.

As an impurity scavenger, 250 ml of tri-n-octylaluminum (TNOA) (25 wt. % in toluene, Akzo Noble) was diluted in 22.83 kilogram of hexane. The diluted TNOA solution was stored in a 37.9-liter cylinder under nitrogen blanket. The solution was used for all polymerization runs until about 90% of consumption, and then a new batch was prepared. Feed rates of the tri-n-octylaluminum (TNOA) solution varied from polymerization reaction to reaction, ranging from 0 (no scavenger) to 4 ml per minutes in order to optimize the overall catalyst efficiency.

The reactor was first cleaned by continuously pumping solvent (e.g., hexane, fluorocarbon) and scavenger through the reactor system for at least one hour at a maximum allowed temperature (about 150° C.). After cleaning, the reactor was heated/cooled to the desired temperature using water/steam mixture flowing through the reactor jacket and controlled at a set pressure with controlled solvent/fluorocarbon flow. Monomers and catalyst solutions were then fed into the reactor. An automatic temperature control system was used to control and maintain the reactor at a set temperature. Onset of polymerization activity was determined by observations of a viscous product and lower temperature of water-steam mixture. Once the activity was established and system reached steady state, the reactor was lined out by continuing operating the system under the established condition for a time period of at least five times of mean residence time prior to sample collection. The resulting mixture, containing mostly solvent/fluorocarbon, polymer and unreacted monomers, was collected in a collection box. The collected samples were first air-dried in a hood to evaporate most of the solvent/fluorocarbon, and then dried in a vacuum oven at a temperature of about 90° C. for about 12 hours. The vacuum oven dried samples were weighed to obtain yields. All the reactions were carried out at a pressure of 2.41 MPa-g. The detailed polymerization conditions are listed in Table E2.

TABLE E2
Polymerization and polymer properties

| | Run # | | |
|---|---|---|---|
| | EP4 | | |
| | comparative | EP5 | EP6 |
| Reaction temperature (° C.) | 80 | 80 | 80 |
| Propylene feed rate (g/min) | 14 | 14 | 14 |
| Ethylene feed rate (SLPM) | 0.3 | 0.3 | 1.6 |
| Hexane feed rate (ml/min) | 80 | 60 | 60 |
| HFC245fa feed rate (ml/min) | 0 | 20 | 20 |
| Catalyst feed rate (mol/min) | 2.90E−07 | 5.76E−07 | 5.76E−07 |
| Yield (gram/min) | 3.7 | 1.1 | 2.4 |
| Conversion (%) | 25.6 | 7.4 | 15.1 |
| Mn (g/mol) | 267,200 | 48,800 | 63,400 |
| Mw (g/mol) | 862,900 | 112,000 | 145,000 |
| Mz (g/mol) | 1,957,500 | 230,300 | 330,200 |
| Mw/Mn | 3.2 | 2.3 | 2.3 |
| Tg (° C.) | −29.7 | −46.5 | −58.2 |
| Ethylene (wt %) | 15.9 | 35.4 | 50.1 |

SUVA245fa is 1,1,1,3,3-Pentafluoropropane obtained from Honeywell under the tradename Enovate 3000

Test Methods

Molecular weight (Mw, Mn and Mz) and molecular weight distribution (Mw/Mn) of the polymers, if reported, were determined using gel permeation chromatography (GPC) on a Water 150C high temperature chromatographic unit equipped with a DRI detector and four linear mixed bed columns (Polymer Laboratories PLgel Mixed-B LS, 20-micron particle size). The oven temperature was at 160° C. with the autosampler hot zone at 160° C. and the warm zone at 145° C. About 0.2 wt. % of polymer sample was dissolved in 1,2,4-trichlorobenzene containing 200 ppm 2,6-di-t-butyl-4-methylphenol. The flow rate was 1.0 milliliter/minute and the injection size is 100 microliters.

Peak melting point (Tm) and peak crystallization temperature (Tc) were determined using the following procedure according to ASTM E 794-01. Differential scanning calorimetric (DSC) data was obtained using a TA Instruments model 2910 machine. Samples weighing approximately 7-10 mg were sealed in aluminum sample pans. The DSC data was recorded by first cooling the sample to −100° C. and then gradually heating it to 200° C. at a rate of 10° C./minute. The sample was kept at 200° C. for 5 minutes before a second cooling-heating cycle was applied. Both the first and second cycle thermal events were recorded. Areas under the melting curves were measured and used to determine the heat of fusion and the degree of crystallinity according to ASTM 3417-99. The percent crystallinity was calculated using the formula, [area under the curve (Joules/gram)/B(Joules/gram)]*100, where B is the heat of fusion for the homopolymer of the major monomer component. These values for B are to be obtained from the Polymer Handbook, Fourth Edition, published by John Wiley and Sons, New York 1999. A value of 189 J/g (B) was used as the heat of fusion for 100% crystalline polypropylene.

The glass transition temperature (Tg) was measured by ASTM E 1356 using a TA Instruments model 2910 machine.

The ethylene content of ethylene/propylene copolymers was determined using FTIR according to the following technique. A thin homogeneous film of polymer, presses at a temperature of about 150° C., was mounted on a Perkin Elmer Spectrum 2000 infrared spectrophotometer. A full spectrum of the sample from 600 cm⁻¹ to 4000 cm⁻¹ was recorded and the ethylene content in wt. % was calculated according to the following equation:
ethylene content(wt. %)=72.698−86.495X+13.696X²
where X=AR/(AR+1). The area under propylene band at ˜1165 cm⁻¹ and the area of ethylene band at ˜732 cm⁻¹ in the spectrum were calculated. The baseline integration range for the methylene rocking band is nominally from 695 cm⁻¹ to the minimum between 745 and 775 cm⁻¹. For the polypropylene band the baseline and integration range is nominally from 1195 to 1126 cm⁻¹. AR is the ratio of the area for the peak at ˜1165 cm⁻¹ to the area of the peak at ˜732 cm⁻¹.

All documents described herein are incorporated by reference herein, including any priority documents and/or testing procedures. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law.

1. A process for making polyolefin comprising contacting olefin monomers under polymerization conditions in the presence of a fluorinated hydrocarbon with an activated, nonmetallocene, metal-centered, heteroaryl ligand catalyst.

2. The process of claim 1 wherein the metal component of the catalyst is hafnium or zirconium.

3. The process of claim 1 in which the catalyst comprises a ligand represented by the formula (1): 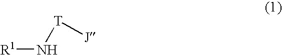
wherein R¹ is represented by the formula (2): 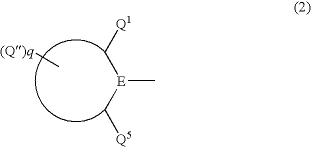
where
Q¹ and Q⁵ are substituents on the ring other than to atom E, where at least one of Q¹ or Q⁵ has at least 2 atoms;
E is selected from the group consisting of carbon and nitrogen;
q is 1, 2, 3, 4 or 5;
Q″ is selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof;
T is a bridging group selected group consisting of —CR²R³— and —SiR²R³—;
R² and R³ are each, independently, selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, halide, nitro, and combinations thereof; and
J″ is selected from the group consisting of heteroaryl and substituted heteroaryl.

4. The process of claim 2, in which the catalyst comprises a ligand represented by the formula (3): 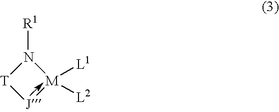
where
M is zirconium or hafnium;
R¹, T, R² and R³ are as defined in claim 3,
J″′ is selected from the group of substituted heteroaryls with 2 atoms bonded to the metal M, at least one of those atoms being a heteroatom, and with one atom of J″′ is bonded to M via a dative bond, the other through a covalent bond; and
L¹ and L² are independently selected from the group consisting of halide, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations of these radicals.

5. The process of claim 2 where the nonmetallocene, metal-centered, heteroaryl ligand catalyst is represented by the formula (4): 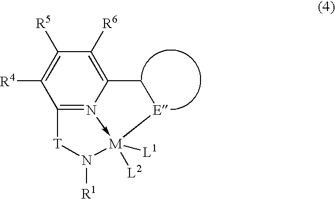
where
M, L¹ and L² are as defined in claim 4;
R⁴, R⁵, and R⁶ are independently selected from the group consisting of hydrogen, alkyl, substituted alkyl, cycloalkyl, substituted cycloalkyl, heteroalkyl, substituted heteroalkyl, heterocycloalkyl, substituted heterocycloalkyl, aryl, substituted aryl, heteroaryl, substituted heteroaryl, alkoxyl, aryloxyl, silyl, boryl, phosphino, amino, thio, seleno, nitro, and combinations thereof, optionally, two or more R⁴, R⁵, and R⁶ groups may be joined to form a fused ring system having from 3-50 non-hydrogen atoms in addition to the pyridine ring, or, optionally, any combination of R², R³, and R⁴, may be joined together in a ring structure;
R¹, T, R² and R³ are as defined in claim 3;
and
E″ is either carbon or nitrogen and is part of an cyclic aryl, substituted aryl, heteroaryl, or substituted heteroaryl group.

6. The process of claim 1 wherein the catalyst is represented by the one or both of the following formulae:

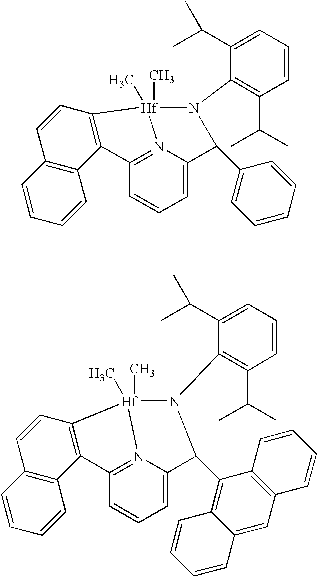

7. The process of claim 1 where the activator comprises an alumoxane.

8. The process of claim 1 where the activator comprises methylalumoxane.

9. The process of claim 1 where the activator comprises one or more of triethylammonium tetraphenylborate, N,N-dimethylanilinium tetraphenylborate, tripropylammonium tetrakis(pentafluorophenyl)borate, N,N-dimethylanilinium n-butyltris(pentafluorophenyl)borate, triethylammonium tetrakis(2,3,4,6-tetrafluorophenyl)borate, N,N-diethylanilinium tetrakis(2,3,4,6-tetrafluorophenyl)borate, and N,N-dimethyl-2,4,6-trimethylanilinium tetrakis(2,3,4,6-tetrafluorop-henyl)borate; di-(i-propyl)ammonium tetrakis(pentafluorophenyl)borate, dicyclohexylammonium tetrakis(pentafluorophenyl)borate; triphenylphosphonium tetrakis(pentafluorophenyl)borate, tri(o-tolyl)phosphonium tetrakis(pentafluorophenyl)borate, tri(2,6-dimethylphenyl)phosphonium tetrakis(pentafluorophenyl)borate; diphenyloxonium tetrakis(pentafluorophenyl)borate, di(o-tolyl)oxonium tetrakis(pentafluorophenyl)borate, di(2,6-dimethylphenyl)oxonium tetrakis(pentafluorophenyl)borate; diphenylsulfonium tetrakis(pentafluorophenyl)borate, di(o-tolyl)sulfonium tetrakis(pentafluorophenyl)borate, di(2,6-dimethylphenyl)sulfonium tetrakis(pentafluorophenyl)borate, trimethylsilylium tetrakis(pentafluorophenyl)borate, and triethylsilylium(tetrakispentafluoro)phenylborate.

10. The process of claim 1 where the activator comprises one or more of trimethylammonium tetraphenylborate, triethylammonium tetraphenylborate, tripropylammonium tetraphenylborate, tri(n-butyl)ammonium tetraphenylborate, tri(tert-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium)tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluorophenyl)borate, dimethyl(tert-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium)tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(tert-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(tert-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(tert-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium)tetrakis(3,5-bis(trifluoromethyl)phenyl)borate, di-(iso-propyl)ammonium tetrakis(pentafluorophenyl)borate, and dicyclohexylammonium tetrakis(pentafluorophenyl)borate; tri(o-tolyl)phosphonium tetrakis(pentafluorophenyl)borate, tri(2,6-dimethylphenyl)phosphonium tetrakis(pentafluorophenyl)borate, tropillium tetraphenylborate, triphenylcarbenium tetraphenylborate, triphenylphosphonium tetraphenylborate, triethylsilylium tetraphenylborate, benzene(diazonium)tetraphenylborate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium) tetrakis-(2,3,4,6-tetrafluorophenyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, or benzene(diazonium)tetrakis(3,5-bis(trifluoromethyl)phenyl)borate.

11. The process of claim 1 wherein the process is a series reactor process for making a polymer blend, the blend comprising (A) a copolymer of propylene and ethylene, and (B) a propylene homopolymer, the process comprising: a) contacting in a first reactor (i) propylene, (ii) ethylene, and (iii) the activated, nonmetallocene, metal-centered, heteroaryl ligand catalyst under polymerization conditions such that at least about 50 wt % of the propylene and substantially all of the ethylene are converted to the copolymer, the propylene, ethylene, catalyst, and copolymer forming a reaction mass within the first reactor; b) transferring the reaction mass of the first reactor to a second reactor; c) feeding additional propylene to the second reactor; d) contacting within the second reactor under polymerization conditions the propylene fed to the second reactor with the reaction mass from the first reactor to make the propylene homopolymer; and e) recovering the blend from the second reactor, where the fluorinated hydrocarbon is present in the first reactor, the second reactor or in both reactors.

12. The process of claim 1 wherein the process is a parallel reactor process for making a polymer blend, the blend comprising (A) a first polymer comprising units derived from at least one of propylene, ethylene and an unsaturated comonomer other than ethylene, and (B) a second polymer comprising units derived from at least one of propylene, ethylene and an unsaturated comonomer other than ethylene, the first and second polymers different from one another, the process comprising: a) contacting in a first reactor under polymerization conditions the activated, nonmetallocene, metal-centered, heteroaryl ligand catalyst and at least one of propylene, ethylene and an unsaturated comonomer other than ethylene to make the first polymer; b) contacting in a second reactor under polymerization conditions at least one of propylene, ethylene and an unsaturated comonomer other than ethylene to make the second polymer; c) recovering the first polymer from the first reactor and the second polymer from the second reactor; and (d) blending the first and second polymers to form the polymer blend; with the proviso that at least one of the first and second polymers comprise either (1) a propylene homopolymer or (2) a propylene/ethylene or propylene unsaturated comonomer copolymer, where the fluorinated hydrocarbon is present in the first reactor, the second reactor or in both reactors.

13. The process of claim 11 wherein fluorinated hydrocarbon is present in the first reactor.

14. The process of claim 11 wherein fluorinated hydrocarbon is present in the second reactor.

15. The process of claim 1 wherein the fluorinated hydrocarbon is represented by the formula: CₓH_{y}F_{z} wherein x is an integer from 1 to 40, y is an integer greater than or equal to 0 and z is an integer and is at least one.

16. The process of claim 15 wherein the fluorinated hydrocarbon comprises a perfluorinated hydrocarbon.

17. The process of claim 15, wherein the fluorinated hydrocarbon comprises a hydrofluorocarbon.

18. The process of claim 15 wherein the fluorinated hydrocarbon comprises one or more of fluoromethane; difluoromethane; trifluoromethane; fluoroethane; 1,1-difluoroethane; 1,2-difluoroethane; 1,1,1-trifluoroethane; 1,1,2-trifluoroethane; 1,1,1,2-tetrafluoroethane; 1,1,2,2-tetrafluoroethane; 1,1,1,2,2-pentafluoroethane; 1-fluoropropane; 2-fluoropropane; 1,1-difluoropropane; 1,2-difluoropropane; 1,3-difluoropropane; 2,2-difluoropropane; 1,1,1-trifluoropropane; 1,1,2-trifluoropropane; 1,1,3-trifluoropropane; 1,2,2-trifluoropropane; 1,2,3-trifluoropropane; 1,1,1,2-tetrafluoropropane; 1,1,1,3-tetrafluoropropane; 1,1,2,2-tetrafluoropropane; 1,1,2,3-tetrafluoropropane; 1,1,3,3-tetrafluoropropane; 1,2,2,3-tetrafluoropropane; 1,1,1,2,2-pentafluoropropane; 1,1,1,2,3-pentafluoropropane; 1,1,1,3,3-pentafluoropropane; 1,1,2,2,3-pentafluoropropane; 1,1,2,3,3-pentafluoropropane; 1,1,1,2,2,3-hexafluoropropane; 1,1,1,2,3,3-hexafluoropropane; 1,1,1,3,3,3-hexafluoropropane; 1,1,1,2,2,3,3-heptafluoropropane; 1,1,1,2,3,3,3-heptafluoropropane; 1-fluorobutane; 2-fluorobutane; 1,1-difluorobutane; 1,2-difluorobutane; 1,3-difluorobutane; 1,4-difluorobutane; 2,2-difluorobutane; 2,3-difluorobutane; 1,1,1-trifluorobutane; 1,1,2-trifluorobutane; 1,1,3-trifluorobutane; 1,1,4-trifluorobutane; 1,2,2-trifluorobutane; 1,2,3-trifluorobutane; 1,3,3-trifluorobutane; 2,2,3-trifluorobutane; 1,1,1,2-tetrafluorobutane; 1,1,1,3-tetrafluorobutane; 1,1,1,4-tetrafluorobutane; 1,1,2,2-tetrafluorobutane; 1,1,2,3-tetrafluorobutane; 1,1,2,4-tetrafluorobutane; 1,1,3,3-tetrafluorobutane; 1,1,3,4-tetrafluorobutane; 1,1,4,4-tetrafluorobutane; 1,2,2,3-tetrafluorobutane; 1,2,2,4-tetrafluorobutane; 1,2,3,3-tetrafluorobutane; 1,2,3,4-tetrafluorobutane; 2,2,3,3-tetrafluorobutane; 1,1,1,2,2-pentafluorobutane; 1,1,1,2,3-pentafluorobutane; 1,1,1,2,4-pentafluorobutane; 1,1,1,3,3-pentafluorobutane; 1,1,1,3,4-pentafluorobutane; 1,1,1,4,4-pentafluorobutane; 1,1,2,2,3-pentafluorobutane; 1,1,2,2,4-pentafluorobutane; 1,1,2,3,3-pentafluorobutane; 1,1,2,4,4-pentafluorobutane; 1,1,3,3,4-pentafluorobutane; 1,2,2,3,3-pentafluorobutane; 1,2,2,3,4-pentafluorobutane; 1,1,1,2,2,3-hexafluorobutane; 1,1,1,2,2,4-hexafluorobutane; 1,1,1,2,3,3-hexafluorobutane, 1,1,1,2,3,4-hexafluorobutane; 1,1,1,2,4,4-hexafluorobutane; 1,1,1,3,3,4-hexafluorobutane; 1,1,1,3,4,4-hexafluorobutane; 1,1,1,4,4,4-hexafluorobutane; 1,1,2,2,3,3-hexafluorobutane; 1,1,2,2,3,4-hexafluorobutane; 1,1,2,2,4,4-hexafluorobutane; 1,1,2,3,3,4-hexafluorobutane; 1,1,2,3,4,4-hexafluorobutane; 1,2,2,3,3,4-hexafluorobutane; 1,1,1,2,2,3,3-heptafluorobutane; 1,1,1,2,2,4,4-heptafluorobutane; 1,1,1,2,2,3,4-heptafluorobutane; 1,1,1,2,3,3,4-heptafluorobutane; 1,1,1,2,3,4,4-heptafluorobutane; 1,1,1,2,4,4,4-heptafluorobutane; 1,1,1,3,3,4,4-heptafluorobutane; 1,1,1,2,2,3,3,4-octafluorobutane; 1,1,1,2,2,3,4,4-octafluorobutane; 1,1,1,2,3,3,4,4-octafluorobutane; 1,1,1,2,2,4,4,4-octafluorobutane; 1,1,1,2,3,4,4,4-octafluorobutane; 1,1,1,2,2,3,3,4,4-nonafluorobutane; 1,1,1,2,2,3,4,4,4-nonafluorobutane; 1-fluoro-2-methylpropane; 1,1-difluoro-2-methylpropane; 1,3-difluoro-2-methylpropane; 1,1,1-trifluoro-2-methylpropane; 1,1,3-trifluoro-2-methylpropane; 1,3-difluoro-2-(fluoromethyl)propane; 1,1,1,3-tetrafluoro-2-methylpropane; 1,1,3,3-tetrafluoro-2-methylpropane; 1,1,3-trifluoro-2-(fluoromethyl)propane; 1,1,1,3,3-pentafluoro-2-methylpropane; 1,1,3,3-tetrafluoro-2-(fluoromethyl)propane; 1,1,1,3-tetrafluoro-2-(fluoromethyl)propane; fluorocyclobutane; 1,1-difluorocyclobutane; 1,2-difluorocyclobutane; 1,3-difluorocyclobutane; 1,1,2-trifluorocyclobutane; 1,1,3-trifluorocyclobutane; 1,2,3-trifluorocyclobutane; 1,1,2,2-tetrafluorocyclobutane; 1,1,3,3-tetrafluorocyclobutane; 1,1,2,2,3-pentafluorocyclobutane; 1,1,2,3,3-pentafluorocyclobutane; 1,1,2,2,3,3-hexafluorocyclobutane; 1,1,2,2,3,4-hexafluorocyclobutane; 1,1,2,3,3,4-hexafluorocyclobutane; and 1,1,2,2,3,3,4-heptafluorocyclobutane.

19. The process of claim 18 wherein the fluorinated hydrocarbon comprises one or more of difluoromethane, trifluoromethane, 1,1-difluoroethane, 1,1,1-trifluoroethane, fluoromethane, and 1,1,1,2-tetrafluoroethane.

20. The process of claim 18 wherein the fluorinated hydrocarbon comprises one or more of 1,1,1,3,3,3-hexafluoropropane, 1,1,1,2-tetrafluoroethane, 1,1,1,3,3-pentafluoropropane, 1,1,1,3,3-pentafluorobutane, octafluorocyclobutane, and 2,3-dihydrodecafluoropentane.

21. The process of claim 1 where the fluorinated hydrocarbon is present at 5 to 99 volume % based upon the volume of the polymerization medium.

22. The process of claim 21 where the fluorinated hydrocarbon is present at 10 to 90 volume % based upon the volume of the polymerization medium.

23. The process of claim 22 where the fluorinated hydrocarbon is present at 20 to 70 volume % based upon the volume of the polymerization medium.

24. The process of claim 23 where the fluorinated hydrocarbon is present at 20 to 60 volume % based upon the volume of the polymerization medium.

25. The process of claim 24 where the fluorinated hydrocarbon is present at 30 to 50 volume % based upon the volume of the polymerization medium.

26. The process of claim 1 wherein the polymerization occurs at a temperature of 70° C. or more.

27. The process of claim 1 wherein the fluorinated hydrocarbon is present at more than 5 weight %, based upon the weight of the fluorocarbon and any hydrocarbon solvent present in the reactor.

28. The process of claim 1 wherein the process is a continuous process.

29. The process of claim 1 where the monomers to be polymerized are aliphatic or alicyclic hydrocarbons.

30. The process of claim 1 where the monomers to be polymerized are selected from the group consisting of ethylene, propylene, butene, pentene, hexene, heptene, octene, nonene, decene, undecene, and dodecene.

31. The process of claim 14 wherein z is 2 or more.
